(19) United States
(12) Patent Application Publication
(10) Pub. No.: US 2025/0168510 A1
(43) Pub. Date: May 22, 2025

(54) IMAGING DEVICE AND ZOOM CONTROL METHOD

(71) Applicant: Sony Group Corporation, Tokyo (JP)

(72) Inventors: Sumino Sato, Kanagawa (JP); Akiko Yoshimoto, Tokyo (JP)

(21) Appl. No.: 18/721,369

(22) PCT Filed: Jan. 24, 2023
(86) PCT No.: PCT/JP2023/002071

§ 371 Date: Jan. 29, 2025

(30) Foreign Application Priority Data
Jan. 28, 2022 (JP) 2022-012095

(51) Int. Cl. H04N 23/69; H04N 23/63

(52) U.S. Cl. CPC H04N 23/69; H04N 23/632; H04N 23/633

(57) ABSTRACT

This imaging device includes a storage unit configured to store zoom setting information that is set by an operation and includes at least one of a zoom time, a zoom speed, or a target zoom magnification, and a control unit configured to perform, on the basis of a first operation acting as a trigger for starting zoom variation that causes a zoom magnification to change to a wide-end side or a tele-end side, the zoom variation reflecting the zoom setting information.

### TECHNICAL FIELD

The present technology relates to an imaging device and a zoom control method, and relates to a technical field of a zoom operation of an imaging device.

### BACKGROUND ART

As an imaging device, a digital camera and a digital video camera that capture still images or videos, a smartphone and a tablet terminal each having imaging capabilities, and the like are known. Such imaging devices may have a zoom function. Image representation by means of such a zoom function is important for image content creation, and it is required that the zoom function be easy to operate at the time of imaging. For example, the following Patent Document 1 discloses a technique to implement a zoom operation with good operability.

### CITATION LIST

### Patent Document

Patent Document 1: Japanese Patent Application Laid-Open No. 2018-173655

### SUMMARY OF THE INVENTION

### Problems to be Solved by the Invention

Recently, posting videos captured by users using imaging devices such as digital video cameras or smartphones on video-sharing sites, social networking services (SNS), and the like is becoming increasingly popular.

Under such an environment, the user himself/herself may capture an image while moving, or the user himself/herself may become a subject, so that it is required that the imaging device suitable for imaging in such a case have high operability.

The present disclosure therefore proposes a technique to improve convenience of zoom operation.

### Solutions to Problems

An imaging device according to the present technology includes:
a storage unit configured to store zoom setting information that is set by an operation and includes at least one of a zoom time, a zoom speed, or a target zoom magnification; and
a control unit configured to perform, on the basis of a first operation acting as a trigger for starting zoom variation for changing a zoom magnification to a wide-end side or a tele-end side, the zoom variation reflecting the zoom setting information.

For example, in a case of optical zoom, the zoom variation refers to changing the zoom magnification by moving a zoom lens. In a case of signal processing such as digital zoom, the zoom variation also refers to changing the zoom magnification. In the present technology, an operation such as a touch operation is used as a trigger operation to perform zoom variation reflecting a preset zoom time and the like.

### BRIEF DESCRIPTION OF DRAWINGS

FIG. 1 is a plan view, a front view, a side view, and a rear view of an imaging device of an embodiment of the present technology.

FIG. 2 is a block diagram of an internal configuration of the imaging device of the embodiment.

FIG. 3 is an explanatory diagram of a direct touch icon of the embodiment.

FIG. 4 is an explanatory diagram when the direct touch icon of the embodiment is disabled.

FIG. 5 is an explanatory diagram of a display example of the direct touch icon in a still image mode of the embodiment.

FIG. 6 is an explanatory diagram of a display example of the direct touch icon in a still image standby mode of the embodiment.

FIG. 7 is an explanatory diagram of a display example of the direct touch icon during video recording of the embodiment.

FIG. 8 is a flowchart of a processing example related to the direct touch icon of the embodiment.

FIG. 9 is a flowchart of a processing example related to the direct touch icon of the embodiment.

FIG. 10 is a flowchart of a processing example related to the direct touch icon of the embodiment.

FIG. 11 is an explanatory diagram of a display state when a panel is retracted of the embodiment.

FIG. 12 is an explanatory diagram of a display state when the panel is opened of the embodiment.

FIG. 13 is an explanatory diagram of a display state when the panel is flipped of the embodiment.

FIG. 14 is an explanatory diagram of a function menu display of the embodiment.

FIG. 15 is an explanatory diagram of a playback mode display of the embodiment.

FIG. 16 is an explanatory diagram of a zoom magnification setting of the embodiment.

FIG. 17 is an explanatory diagram of a zoom menu display of the embodiment.

FIG. 18 is an explanatory diagram of a zoom menu display of the embodiment.

FIG. 19 is an explanatory diagram of another example of an operation icon 40 of the embodiment.

FIG. 20 is a flowchart of a processing example related to step zoom of the embodiment.

FIG. 21 is an explanatory diagram of zoom magnification transition by the step zoom of the embodiment.

FIG. 22 is an explanatory diagram of an example of auto zoom of the embodiment.

FIG. 23 is an explanatory diagram of an operation element for time-scheduled auto zoom of the embodiment.

FIG. 24 is an explanatory diagram of settings of a zoom speed and a zoom time of the embodiment.

FIG. 25 is a flowchart of processing including the time-scheduled auto zoom of the embodiment.

FIG. 26 is a flowchart of processing of a first example of the time-scheduled auto zoom of the embodiment.

FIG. 27 is an explanatory diagram of a display example when the time-scheduled auto zoom is performed of the embodiment.

FIG. 28 is a flowchart of processing of a second example of the time-scheduled auto zoom of the embodiment.

FIG. 29 is an explanatory diagram of how to change the setting of the zoom time of the embodiment.

FIG. 30 is an explanatory diagram of how to change the setting of the zoom speed of the embodiment.

FIG. 31 is a flowchart of setting change processing of the embodiment.

FIG. 32 is a flowchart of a first example of auto zoom based on a remaining recording time of the embodiment.

FIG. 33 is a flowchart of a second example of the auto zoom based on the remaining recording time of the embodiment.

FIG. 34 is a flowchart of auto zoom based on a start magnification and an end magnification of the embodiment.

FIG. 35 is an explanatory diagram of a display example where the zoom time and the magnification can be set of the embodiment.

FIG. 36 is an explanatory diagram of a display example where the zoom speed and the magnification can be set of the embodiment.

### MODE FOR CARRYING OUT THE INVENTION

Hereinafter, an embodiment will be described in the following order.
<1. Configuration of imaging device>
<2. Processing related to direct touch icon>
<3. Other examples of step zoom>
<4. Auto zoom>
<5. Conclusion and modifications>

### 1. Configuration of Imaging Device

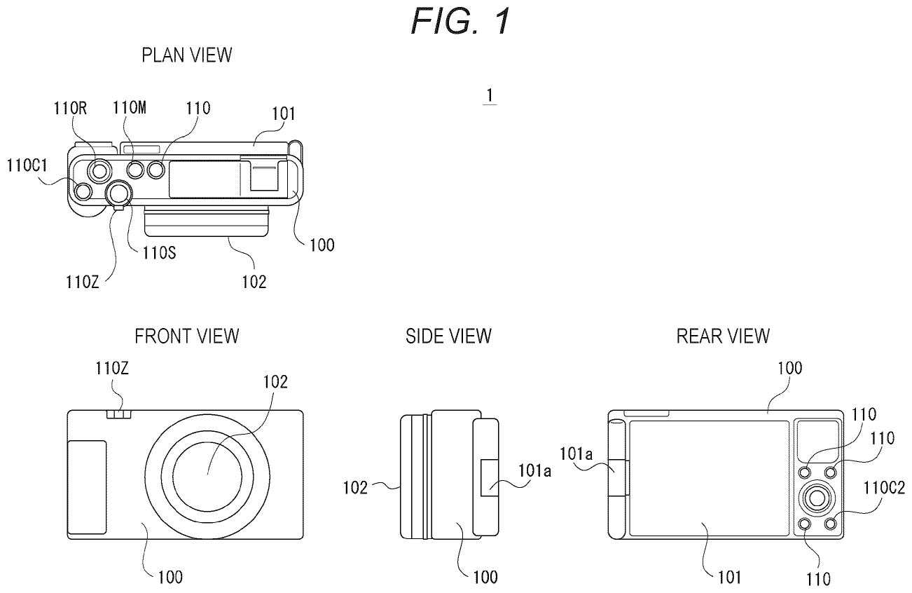

FIG. 1 is a plan view, a front view, a side view, and a rear view of an imaging device 1 of the embodiment.

The imaging device 1 is a so-called digital camera, and is capable of capturing both still images and videos.

In the imaging device 1, a lens unit 102 is disposed on a front side of a main body housing 100 constituting a camera main body. At the time of imaging, a shutter on the front side is opened to expose a lens at the time of imaging.

On a back side (user side) of the imaging device 1, for example, a display panel 101 including a display device such as a liquid crystal display (LCD) or an organic electro-luminescence (EL) display is provided.

In this example, the display panel 101 is held by a hinge 101a so as to be openable and rotatable. The drawing illustrates a state where a display surface of the display panel 101 is not shown.

The user can visually recognize an image at the time of imaging, an image at the time of playback, and various types of information on the display panel 101.

Operation elements 110 corresponding to various hardware are provided on the main body housing 100 of the imaging device 1.

For example, as the operation elements 110, various forms such as a key, a dial, and a combined press-rotation operation element are provided to achieve various operation functions. For example, a menu operation, a playback operation, a mode selection operation, a focus operation, a zoom operation, a selection operation of parameters such as a shutter speed and an F value, and the like can be performed.

Although no detailed description will be given of each operation element 110, some operation elements 110 including a shutter button 110S, a zoom lever 110Z, a recording button 110R, and a mode button 110M are arranged on an upper surface side of the main body housing 100, for example.

The recording button 110R is a large-sized operation element located on the upper surface side, so that, for example, in a case where a video contributor places the imaging device 1 on a desk or the like and perform imaging, or in a case where the video contributor holds the imaging device 1 to cause the imaging device 1 to face himself/herself for a selfie, the operation becomes easy.

Operating the zoom lever 110Z in the left-right direction enables a zoom operation to a wide (wide angle) side or a tele (telephoto) side of a zoom state.

Note that, in the present disclosure, the symbols “T” and “W” are used, which means “tele” and “wide”, respectively.

As one of the operation elements 110, custom buttons 110C1 and 110C2 are illustrated. In this example, the custom button 110C1 is disposed on the upper surface of the main body housing 100, and the custom button 110C2 is disposed at a lower right of the back surface of the main body housing 100.

The custom buttons 110C1 and 110C2 are operation elements, each referred to as assignable button, to which a predetermined operation function is pre-assigned in an initial state and to which the user can assign any desired operation function.

Note that the number of custom buttons is not limited to two, and may be one or three or more.

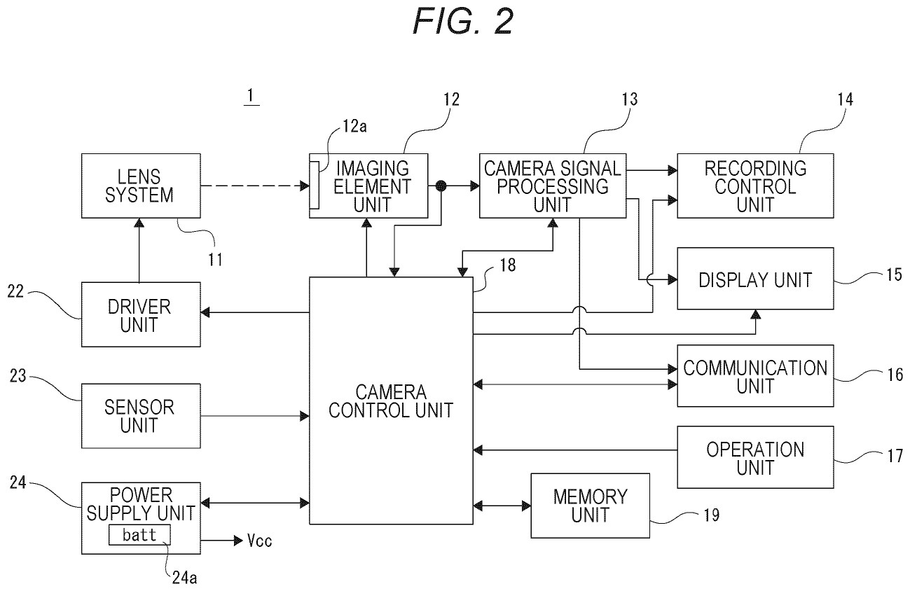

A configuration example of the imaging device 1 will be described with reference to FIG. 2.

The imaging device 1 includes, for example, a lens system 11, an imaging element unit 12, a camera signal processing unit 13, a recording control unit 14, a display unit 15, a communication unit 16, an operation unit 17, a camera control unit 18, a memory unit 19, a driver unit 22, a sensor unit 23, and a power supply unit 24.

The lens system 11 includes lenses such as a zoom lens and a focus lens, a diaphragm mechanism, and the like. Light (incident light) from a subject is guided by the lens system 11 and condensed on the imaging element unit 12.

The imaging element unit 12 includes, for example, an image sensor 12a (imaging element) of a complementary metal oxide semiconductor (CMOS) type, a charge coupled device (CCD) type, or the like.

The imaging element unit 12 performs, for example, correlated double sampling (CDS) processing, automatic gain control (AGC) processing, and the like on an electrical signal obtained by photoelectrically converting the light received by the image sensor 12a, and further performs analog/digital (A/D) conversion processing on the electrical signal. Then, an imaging signal as digital data is output to the camera signal processing unit 13 and the camera control unit 18 to be described later.

The camera signal processing unit 13 is configured as, for example, an image processor with a digital signal processor (DSP) or the like. The camera signal processing unit 13 performs various kinds of signal processing on the digital signal (captured image signal) from the imaging element unit 12. For example, as a camera process, the camera signal processing unit 13 performs preprocessing, synchronization processing, YC generation processing, resolution conversion processing, file formation processing, and the like.

In the preprocessing, clamp processing of clamping the black level of R, G, B to a predetermined level, correction processing between R, G, B color channels, and the like are performed on the captured image signal from the imaging element unit 12.

In the synchronization processing, color separation processing is performed so as to cause image data for each pixel to have all of the R, G, B color components. For example, in a case of an imaging element using a Bayer color filter, demosaicing processing is performed as the color separation processing.

In the YC generation processing, a luminance (Y) signal and a color (C) signal are generated (separated) from image data of R, G, and B.

In the resolution conversion processing, resolution conversion processing is performed on the image data subjected to various kinds of signal processing.

In the file formation processing, the image data subjected to the various kinds of processing described above is subjected to compression encoding for recording or communication, formatting, and generation or addition of metadata, for example, to generate a file for recording or communication.

For example, an image file in a format such as JPEG, tagged image file format (TIFF), or graphics interchange format (GIF) is generated as a still image file. Furthermore, it is also conceivable to generate an image file in an MP4 format or the like used for recording a video and sound conforming to MPEG-4.

Note that it is also conceivable to generate an image file as raw (RAW) image data.

The camera signal processing unit 13 generates the metadata including information regarding processing parameters in the camera signal processing unit 13, various control parameters acquired from the camera control unit 18, information indicating operation states of the lens system 11 and the imaging element unit 12, mode setting information, imaging environment information (date and time, place, and the like), identification information of the imaging device itself, and the like.

Furthermore, the camera signal processing unit 13 can also perform zoom processing of varying the angle of view by changing a cutout range by means of signal processing, such as digital zoom.

The recording control unit 14 performs recording and playback on a storage medium including a non-volatile memory, for example. The recording control unit 14 performs processing of recording images such as video data or still image data or metadata on the storage medium, for example.

Various actual forms of the recording control unit 14 can be considered. For example, the recording control unit 14 may include a flash memory built in the imaging device 1 and a write/read circuit of the flash memory. Alternatively, the recording control unit 14 may be a card recording/playback unit that performs recording/playback access to a storage medium detachably attached to the imaging device 1, such as a memory card (portable flash memory or the like). Alternatively, the recording control unit 14 may be implemented as a hard disk drive (HDD) or the like as a form built in the imaging device 1.

The display unit 15 is a display unit that outputs various displays to a person who captures an image, and is, for example, a display device such as a liquid crystal display (LCD) or an organic electro-luminescence (EL) display disposed in the display panel 101 attached to the housing of the imaging device 1. The display unit 15 may also be a display device in a viewfinder.

The display unit 15 performs various displays on a display screen on the basis of an instruction from the camera control unit 18. For example, the display unit 15 displays a playback image of image data read from the storage medium by the recording control unit 14.

Furthermore, there is a case where image data of a captured image whose resolution has been converted for display by the camera signal processing unit 13 is supplied to the display unit 15, and the display unit 15 performs a display on the basis of the image data of the captured image in accordance with an instruction from the camera control unit 18. With this configuration, a so-called through-the-lens image (subject monitoring image) is displayed on a standby screen in a still image mode, a standby screen in a standby state or during recording in a video mode, and the like.

Furthermore, the display unit 15 performs displays of various operation menus, icons, messages, and the like, that is, graphical user interfaces (GUIs) on the screen on the basis of an instruction from the camera control unit 18.

In an example of the embodiment, for example, the display unit 15 is configured as the display panel 101 illustrated in FIG. 1, but the display unit 15 may be provided separately from the imaging device 1.

The communication unit 16 comprehensively indicates various communication devices and communication processing circuits mounted on the imaging device 1.

For communication performed by the communication unit 16, various communication circuits and communication devices capable of performing communication over a network that is an external communication network (external network communication), local communication with peripheral devices, and the like are provided.

With this configuration, the imaging device 1 transmits and receives captured image data (still image file or video file), metadata, various parameters, and the like to and from, for example, an external information processing device, terminal device, display device, recording device, playback device, and the like.

More specifically, it is conceivable that the communication unit 16 includes, as a network communication unit, some or all of a function of performing communication over a mobile communication network such as 4G or 5G, the Internet, a home network, a local area network (LAN), or the like, a function of performing short-range wireless communication such as Bluetooth (registered trademark), Wi-Fi (registered trademark) communication, or near field communication (NFC), a function of performing infrared communication or the like, a function of performing wired connection communication with another device, and the like.

The operation unit 17 collectively indicates input devices provided for the user to perform various operation inputs. Specifically, the operation unit 17 indicates various operation elements 110 (a key, a dial, a touch panel, a touch pad, and the like) provided in the housing of the imaging device 1.

Furthermore, providing a touch panel on the display unit 15 causes icons and the like displayed on the display unit 15 to act as touch-operated operation elements. The operation provided on this screen is also an example of the operation unit 17.

An operation of the user is detected by the operation unit 17, and a signal corresponding to the input operation is transmitted to the camera control unit 18.

The camera control unit 18 includes a microcomputer (arithmetic processing device) including a central processing unit (CPU).

The memory unit 19 stores information and the like used for processing by the camera control unit 18. The illustrated memory unit 19 comprehensively indicates, for example, a read only memory (ROM), a random access memory (RAM), a flash memory, and the like.

The memory unit 19 may be a memory area provided in a microcomputer chip serving as the camera control unit 18 or may be a separate memory chip.

The camera control unit 18 executes a program stored in the ROM, the flash memory, or the like of the memory unit 19 to control the entire imaging device 1.

For example, the camera control unit 18 controls the operation of each necessary unit such as the shutter speed of the imaging element unit 12, the instruction of various signal processing in the camera signal processing unit 13, the imaging operation and the recording operation based on the user's operation, the playback operation of the recorded image file, the operation of the lens system 11 such as zoom, focus, and diaphragm adjustment in a lens barrel, the user interface operation, the setting of a communication method and the setting of a transmission destination made by the communication unit 16, and the like.

The RAM in the memory unit 19 is used as a work area for various types of data processing of the CPU of the camera control unit 18 to temporarily store data, programs, and the like.

The ROM or the flash memory (non-volatile memory) in the memory unit 19 is used to store an operating system (OS) for the CPU to control each unit, a content file such as an image file, an application program for various operations, firmware, various setting information, and the like.

The various setting information includes communication setting information, an exposure setting, a shutter speed setting, and a mode setting as setting information regarding imaging operation, a white balance setting as setting information regarding image processing, a color setting, a setting regarding image effect, a custom key setting and display setting as setting information regarding operability, and the like.

Furthermore, for example, the non-volatile memory of the memory unit 19 further stores information regarding settings made by an operation of a direct touch icon to be described later, information regarding settings of a step zoom operation and an auto zoom operation, specifically, information regarding effective magnification of the step zoom operation, and zoom setting information such as a zoom time and a zoom speed of auto zoom.

The driver unit 22 is provided with, for example, a motor driver for a zoom lens drive motor, a motor driver for a focus lens drive motor, a motor driver for a diaphragm mechanism motor, and the like.

Such motor drivers each apply a drive current to the corresponding driver in accordance with an instruction from the camera control unit 18 to cause the driver to, for example, move the focus lens or the zoom lens, or open or close a diaphragm blade of the diaphragm mechanism.

The sensor unit 23 comprehensively indicates various sensors mounted on the imaging device 1.

For example, an inertial measurement unit (IMU) is mounted as the sensor unit 23, specifically, an angular velocity (gyro) sensor of three axes of pitch, yaw, and roll can detect an angular velocity, and an acceleration sensor can detect acceleration.

Furthermore, there is a case where, as the sensor unit 23, for example, a position information sensor, an illuminance sensor, and the like are mounted.

Furthermore, it is conceivable that a ranging sensor is provided as the sensor unit 23. A distance from the imaging device 1 to the subject can be measured by the ranging sensor at the time of imaging, and the distance information can be added as metadata to the captured image.

Various information detected by the sensor unit 23, such as position information, distance information, illuminance information, and IMU data are added as metadata to the captured image together with date and time information managed by the camera control unit 18.

The power supply unit 24 outputs a power supply voltage VCC required for each unit using a battery 24a as a power supply. The camera control unit 18 controls on/off of the supply of the power supply voltage VCC by the power supply unit 24, that is, power on/off of the imaging device 1. Furthermore, the camera control unit 18 can detect the state of charge of the battery 24a, that is, the remaining battery level.

Note that the power supply unit 24 may be configured to be able to output the power supply voltage VCC on the basis of an external power supply, for example, via an AC adapter connected to the power supply unit 24 or by receiving the supply of a DC power supply voltage.

Meanwhile, in the present disclosure, how the camera control unit 18 controls a zoom function will be described, so that the zoom function will be described below.

Known examples of the zoom function include optical zoom, smart zoom, clear image zoom, digital zoom, and the like.

The optical zoom is a zoom function performed by moving an incident light path extending to the imaging element unit 12, that is, the zoom lens arranged in the lens system 11 to the W-end side or the T-end side.

This optical zoom enables optical zoom variation by changing a focal length, which prevents deterioration in image quality.

The smart zoom, the clear image zoom, and the digital zoom each correspond to processing of changing the zoom state by means of signal processing.

The smart zoom cuts out and enlarges a part of an image captured with the maximum image size. The zoom magnification applied to images is less than or equal to 1.0×, which prevents deterioration in image quality. In a case where the image size is L size, which is the maximum image size in the image circle with a full-frame lens mounted, the smart zoom cannot be used. Furthermore, even in a case where the image size is M size, which is the maximum image size in the image circle with an APS-C lens mounted, the smart zoom cannot be used.

The clear image zoom applies a zoom magnification of 2.0× or less to images and is therefore greater in degree of deterioration than the smart zoom; however, an interpolation algorithm, artificial intelligence (AI), or the like specific to the clear image zoom, which is different from linear interpolation, is used, so that the clear image zoom is less in degree of deterioration than the digital zoom. When the zoom magnification becomes greater than 2.0×, transition is made to the digital zoom rather than the clear image zoom. Note that a function similar to the clear image zoom may be called by a different name than the clear image zoom.

The digital zoom applies a zoom magnification of greater than 2.0× to images, but performs general linear interpolation, so that the digital zoom is greater in degree of deterioration in image quality than the clear image zoom.

The zoom variation referred to in the present disclosure, that is, a change in zoom magnification includes not only optical zoom that actually moves the zoom lens but also processing of changing a zoom state by means of signal processing. That is, “zoom variation” includes the movement of the zoom lens, but is intended to indicate causing a large change in zoom magnification.

“Zoom position” means not only the position of the zoom lens in a case of the current optical zoom, but also the current zoom magnification.

“Zoom movement distance” may be considered as a movement distance of the zoom lens, but also indicates a virtual distance corresponding to a movement destination range of the zoom magnification.

Furthermore, the symbols “T” and “W” are used to indicate not only the lens movement direction for the optical zoom. As an upper limit and a lower limit of the zoom magnification for the digital zoom and the like, the expressions “T end” and “W end” are used, and the expressions “T-end side” and “W-end side” are used as directions in which the zoom magnification is changed.

### 2. Processing Related to Direct Touch Icon

A direct touch icon (hereinafter referred to as “DTI”) displayed as a user interface (UI) on the imaging device 1 of the embodiment will be described.

The DTI is an icon displayed on the display panel 101 and is an operation element to be used for a direct touch operation. The imaging device 1 is provided with the operation element 110 as a hardware key such as a physical button or a physical lever, and an icon displayed as the DTI also acts as one operation element 110. In particular, the recent spread of smartphones and the like causes an increase in the number of people who are accustomed to touch operations on screens. Therefore, the DTI provides comfortable usability for a user who finds touch operations on screens more intuitive.

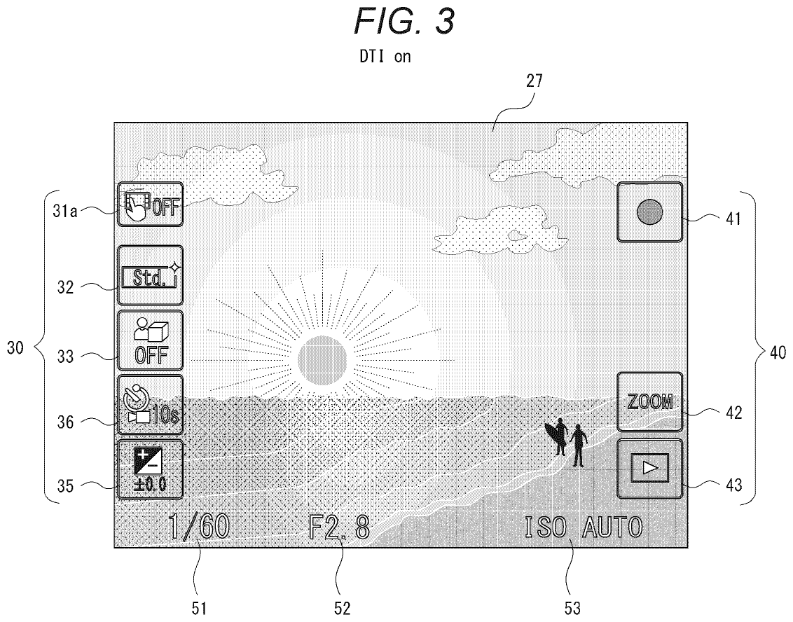

FIG. 3 illustrates a screen example of the display panel 101 when the DTI is enabled. For example, a through-the-lens image is displayed as a standby screen 27 in the video mode.

As the DTI on the standby screen 27, for example, setting icons 30 are vertically arranged and displayed on the left side of the screen, and operation icons 40 are vertically arranged and displayed on the right side of the screen.

In this example, as the setting icon 30, a DTI OFF button 31a, a creative look icon 32, a product review setting icon 33, a video self-timer icon 36, and an exposure compensation icon 35 are displayed.

The DTI OFF button 31a acts as an operation element for disabling a DTI operation function.

The creative look icon 32 acts as an operation element for not only presentation of a set filter but also filter switching.

The product review setting icon 33 acts as an operation element for not only presentation of on/off of the current product review setting but also on/off switching of the product review setting. Note that the product review setting is a mode in which, in a case where a video contributor creates a product introduction video, not a performer but a product is targeted for autofocus.

The video self-timer icon 36 acts as an operation element for not only presentation of a self-timer setting but also a self-timer operation.

The exposure compensation icon 35 acts as an operation element for not only presentation of a state of exposure compensation but also exposure compensation switching.

Furthermore, as the operation icon 40, a REC button 41, a zoom entry button 42, and a playback button 43 are displayed.

The REC button 41 acts as an operation element for a recording (video recording) start operation.

The zoom entry button 42 acts as an operation element for displaying an operation element for a zoom variation operation to be described later.

The playback button 43 acts as an operation element for playback of a recorded still image or video.

Note that, in addition to the DTI, a shutter speed 51, an F value 52, an ISO speed 53, and the like are displayed at the lower part of the screen as a normal display, for example.

The DTI displayed as in FIG. 3 has a touch operation function, but the user can enable/disable the function as desired.

The user can disable the DTI by operating the DTI OFF button 31a.

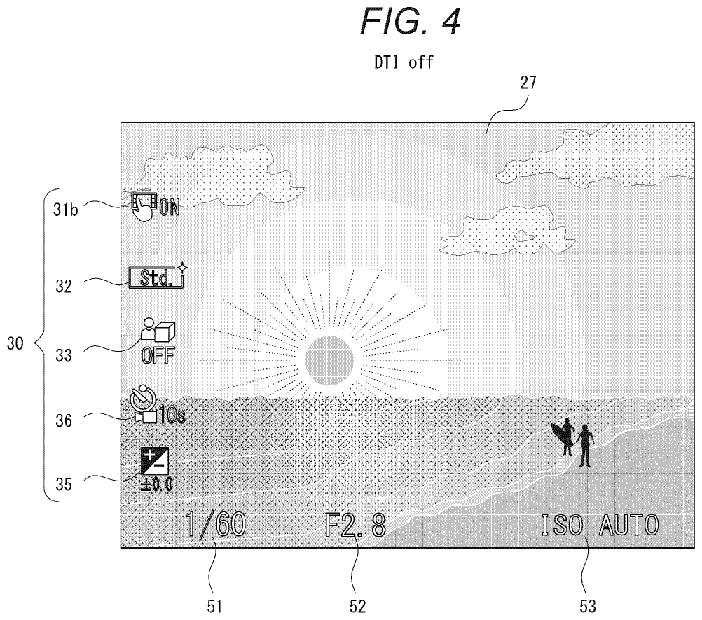

FIG. 4 is a screen example of the display panel 101 when the DTI is disabled.

In this case, a DTI ON button 31b, the creative look icon 32, the product review setting icon 33, the video self-timer icon 36, and the exposure compensation icon 35 are displayed. Note that a display mode is made different from the display mode illustrated in FIG. 3, and the icons are each provided for information presentation with the corresponding operation function disabled. For example, removing a frame of each icon makes the icon look inoperable.

Furthermore, when the DTI is disabled, the operation icon 40 is not displayed.

Enabling/disabling the DTI means enabling/disabling the touch operation function for the DTI.

The setting icon 30 has a role of presenting a setting state and also has a function as an operation element for changing the setting. Therefore, the setting icon 30 is displayed even when the DTI is disabled. In the state illustrated in FIG. 4, the creative look icon 32, the product review setting icon 33, the video self-timer icon 36, and the exposure compensation icon 35 each act as an icon for simply presenting the corresponding state, and even if the user touches the icon, the touch is not detected as an operation.

In the state illustrated in FIG. 4, the DTI ON button 31b is displayed instead of the DTI OFF button 31a illustrated in FIG. 3. When the DTI ON button 31b is touched, transition to the DTI ON state illustrated in FIG. 3 is made.

On the other hand, the operation icon 40 acts as an icon for an operation such as a recording operation, a playback operation, and a zoom operation of the imaging device 1, and does not present any information by itself. Therefore, in a case where the DTI is disabled, the display is erased.

FIGS. 3 and 4 illustrate DTI display examples in the standby state in the video mode; however, the content of each icon is different among the still image mode, the standby state in the video mode, and during recording in the video mode.

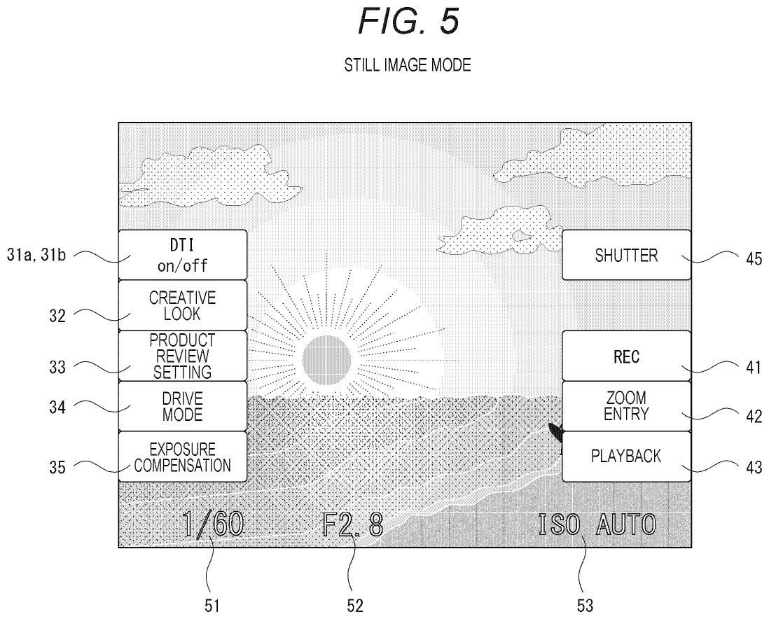

FIGS. 5, 6, and 7 illustrate examples of types of the DTI displayed in the still image mode, the standby state in the video mode, and during recording in the video mode. In each drawing, the icons are illustrated with their respective content descriptions rather than patterns.

As for the setting icon 30, the DTI OFF button 31a (DTI ON button 31b), the creative look icon 32, the product review setting icon 33, and the exposure compensation icon 35 are displayed regardless of which mode is active.

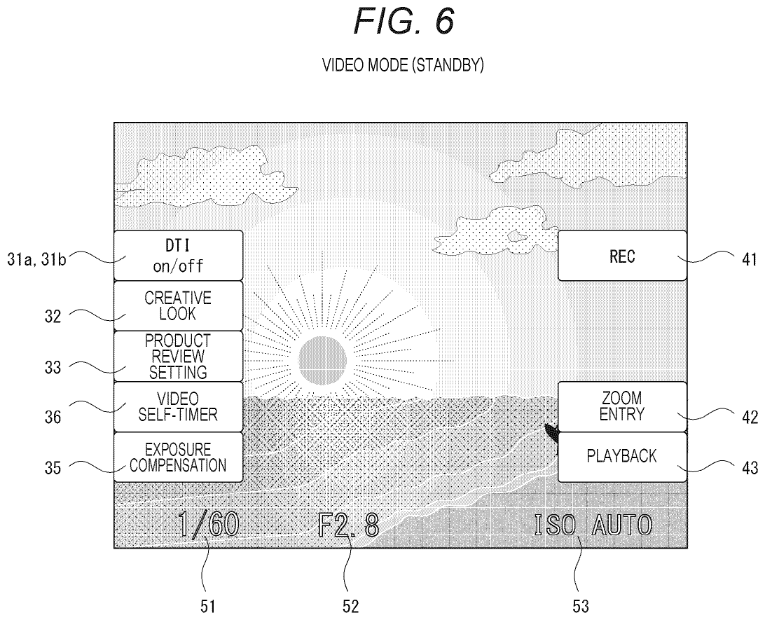

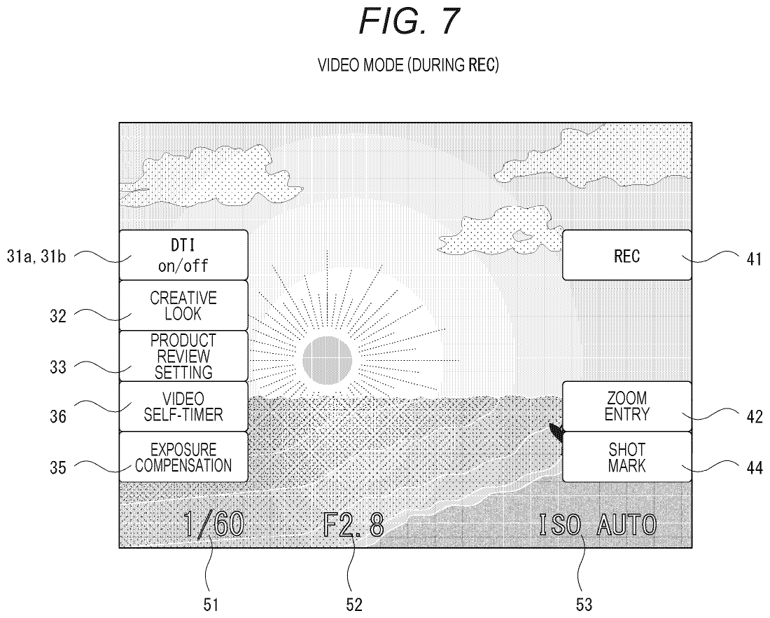

The video self-timer icon 36 is displayed in the video mode as illustrated in FIGS. 6 and 7, and a drive mode icon 34 is displayed instead in the still image mode as illustrated in FIG. 5.

The drive mode icon 34 is an icon acting as an operation element for not only presentation of a single shooting/continuous shooting setting and but also changing the setting.

As for the operation icon 40, in the still image mode illustrated in FIG. 5, the shutter button 45 is displayed instead of the REC button 41 that is displayed in the video mode. Since the shutter button 45 acting as a shutter operation element is displayed at the same position as the REC button 41, the user can easily recognize the position as the position of the recording operation.

Note that video recording is possible even in the still image mode. Therefore, in the still image mode, the REC button 41 is also displayed below the shutter button 45 to enable the video recording operation.

Furthermore, as illustrated in FIG. 7, during recording in the video mode, a shot mark button 44 is displayed instead of the playback button 43. The shot mark button 44 acts as an operation element for marking any desired scene in a video.

During standby in the still image mode and the video mode, it is possible to transition to the playback mode, so that the playback button 43 is displayed as illustrated in FIGS. 5 and 6. On the other hand, when video recording starts, it becomes unable to transition to the playback mode, and it is desired to make a shot mark, so that the playback button 43 is replaced with the shot mark button 44 as illustrated in FIG. 7.

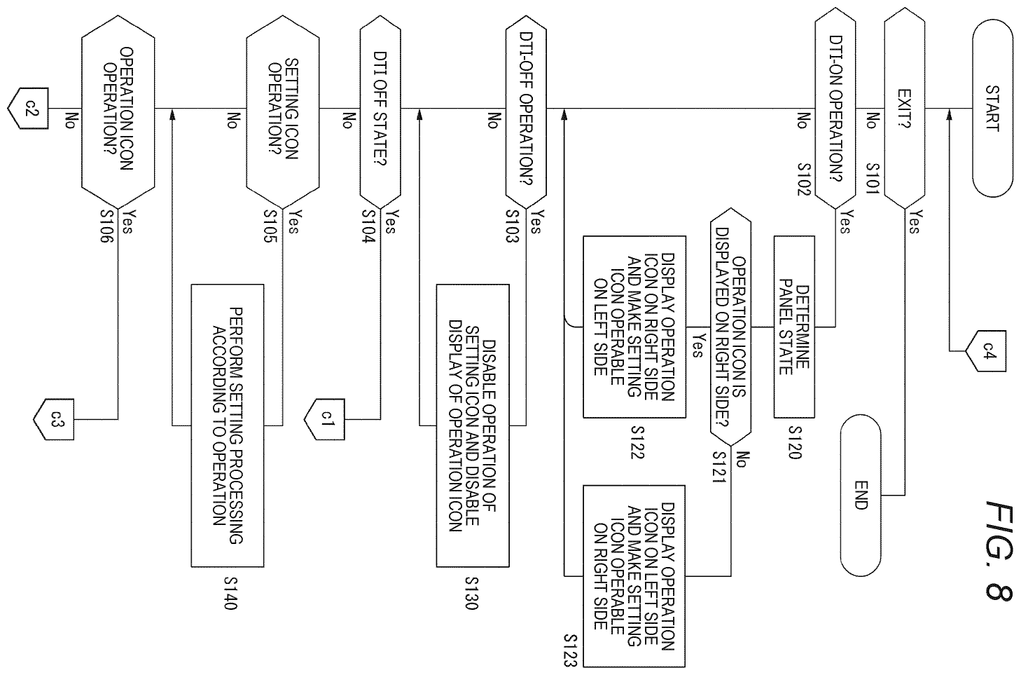

For example, the DTI is displayed as described above, and a processing example related to such a DTI will be described below with reference to the flowcharts of FIGS. 8, 9, and 10. The processing to be described is processing performed by the camera control unit 18 on the basis of a software program, and is mainly processing when a user's operation using the DTI is detected.

In FIGS. 8, 9, and 10, “c1” to “c4” each indicate a connection relationship between the flowcharts.

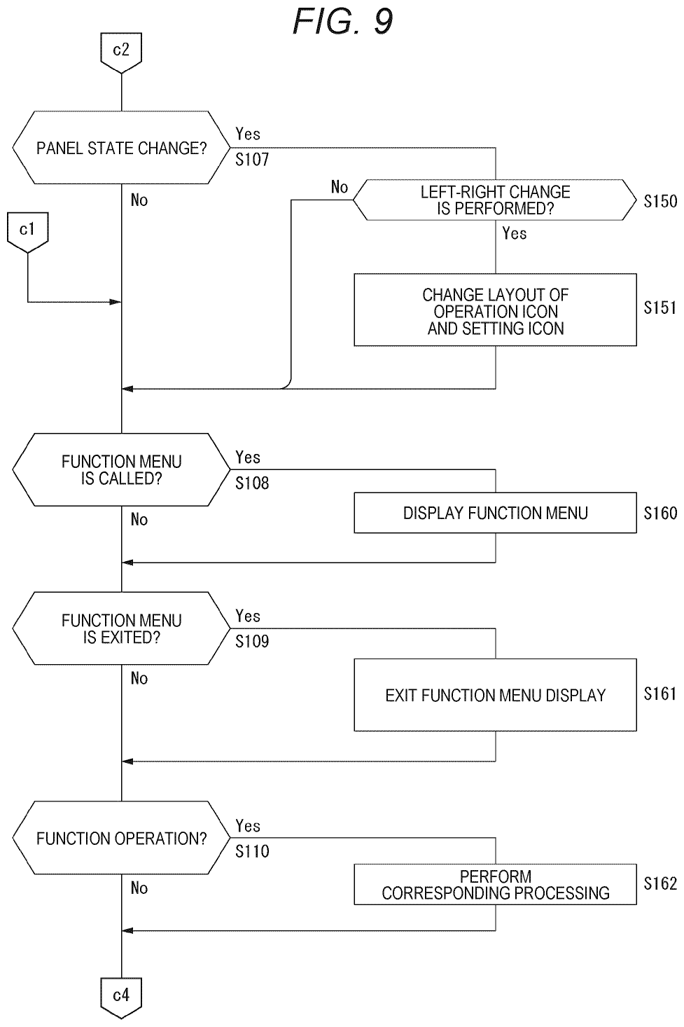

When the imaging device 1 is powered on to enter a mode state in which the DTI display on the screen of the display panel 101 is enabled, the camera control unit 18 starts monitoring loop processing from step S101 in FIG. 8 to step S110 in FIG. 9 mainly as DTI-related processing.

Note that, for example, when the power is on, the initial state is either the DTI ON state or the DTI OFF state. The DTI ON state or the DTI OFF state at the time of the previous power-off or mode transition may be carried over.

In step S101, the camera control unit 18 determines whether or not to exit the monitoring loop processing from step S101 to step S110. For example, in a case where the imaging device 1 is powered off, or when the imaging device 1 enters a mode in which the DTI is not displayed (for example, a menu mode or the like), the processing in FIG. 8 exits.

On the other hand, for example, during a period such as the still image mode or the video mode, it is determined in step S101 that the monitoring loop processing from step S101 to step S110 does not exit, and the monitoring loop processing is repeated.

In step S102, the camera control unit 18 determines whether or not the DTI-ON operation has been performed. For example, it is determined whether or not the DTI ON button 31b has been operated in the display state illustrated in FIG. 4. In the DTI OFF state, the DTI ON button 31b is displayed as illustrated in FIG. 4, so that the user can perform the DTI-ON operation.

In a case where the DTI-ON operation is detected, the camera control unit 18 proceeds to step S120 to determine the state of the display panel 101, and proceeds from step S121 to either step S122 or step S123 to bring about the DTI ON state as illustrated in FIG. 3. That is, as in the example illustrated in FIG. 3, the setting icon 30 of the DTI is brought into an operable display state, and the display of the operation icon 40 starts.

Here, the camera control unit 18 determines the state of the display panel 101 in steps S120 and S121, and selects either step S122 or step S123 to proceed.

In step S122, the setting icon 30 is displayed on the left side on the screen, and the operation icon 40 is displayed on the right side on the screen. That is, the state as illustrated in FIG. 3 is obtained.

On the other hand, in step S123, the setting icon 30 is displayed on the right side on the screen, and the operation icon 40 is displayed on the left side on the screen.

This indicates a change of the layout of the setting icon 30 and the operation icon 40 based on the state (orientation) of the display panel 101. This will be described later together with the processing in step S107.

In step S103, the camera control unit 18 determines whether or not the DTI-OFF operation has been performed. For example, it is determined whether or not the DTI OFF button 31a has been operated in the display state illustrated in FIG. 3. In the DTI ON state, the DTI OFF button 31a is displayed as illustrated in FIG. 3, so that the user can perform the DTI-OFF operation.

In a case where the DTI-OFF operation is detected, the camera control unit 18 proceeds to step S130 to bring about the DTI OFF state as illustrated in FIG. 4. That is, the setting icon 30 of the DTI is brought into an inoperable display state, and the display of the operation icon 40 is disabled.

During the DTI OFF period, the monitoring loop processing of the camera control unit 18 proceeds from step S104 to step S108 in FIG. 9. This is because the operation monitoring in steps S105 and S106 related to the DTI is not required.

During the DTI ON period, the monitoring loop processing of the camera control unit 18 proceeds from step S104 to steps S105 and S106 to monitor the DTI operation.

In step S105, the camera control unit 18 monitors the operation of the setting icon 30 of the DTI. In a case where the operation of the setting icon 30 is detected, the camera control unit 18 performs setting processing based on the detected operation in step S140.

For example, filter switching based on the operation of the creative look icon 32, on/off switching of the product review setting based on the operation of the product review setting icon 33, switching of the drive mode based on the operation of the drive mode icon 34, switching of the exposure compensation mode based on the operation of the exposure compensation icon 35, switching of the video self-timer setting based on the operation of the video self-timer icon 36, and the like are performed as the processing in step S140.

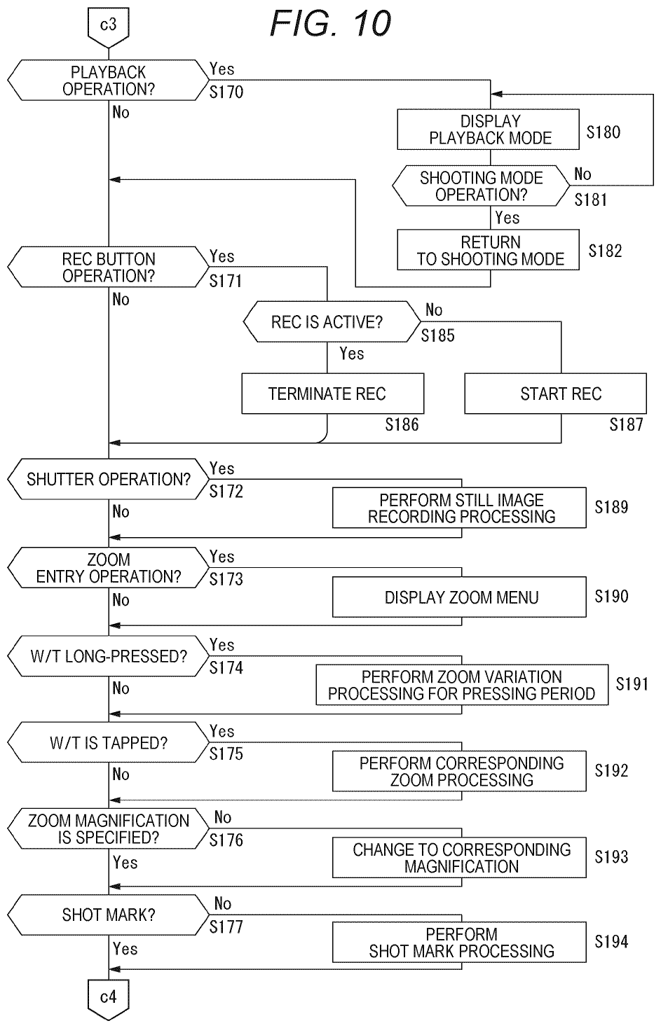

In step S106, the camera control unit 18 monitors the operation of the operation icon 40 of the DTI. In a case where the operation of the operation icon 40 is detected, the camera control unit 18 proceeds to step S170 in FIG. 10.

Details of the processing in FIG. 10 will be described later.

The camera control unit 18 monitors a state change of the display panel 101 in step S107 in FIG. 9 as the monitoring loop processing subsequent to step S106 in FIG. 8.

In a case where the state change of the display panel 101 is detected, the camera control unit 18 proceeds to step S150 to determine whether or not the state change corresponds to a state change that requires a left-right change of the DTI display, and proceeds to step S151 to change the layout of the operation icon 40 and the setting icon 30 if necessary.

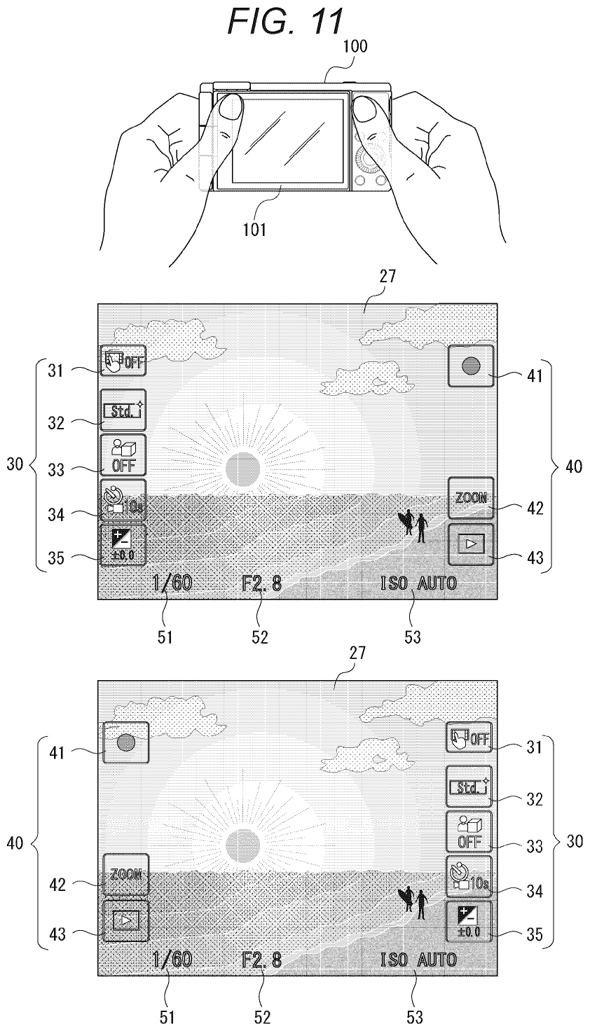

The processing in steps S150 and S151 and the processing in steps S120, S121, S122, and S123 described above will be described with reference to FIGS. 11, 12, and 13.

This processing is processing of switching the left and right display positions of the setting icon 30 and the operation icon 40 on the basis of the orientation state of the display panel 101. The user can use the display panel 101 in any orientation.

The upper part of FIG. 11 illustrates a panel-retracted state. That is, the display panel 101 is in a state where the display panel 101 is retracted in the main body housing 100 of the imaging device 1.

In this case, as illustrated in the middle part of the drawing, the setting icon 30 is displayed on the left side on the screen, and the operation icon 40 is displayed on the right side on the screen.

Alternatively, in this case, as illustrated in the lower part of the drawing, it is conceivable to display the setting icon 30 on the right side and the operation icon 40 on the left side.

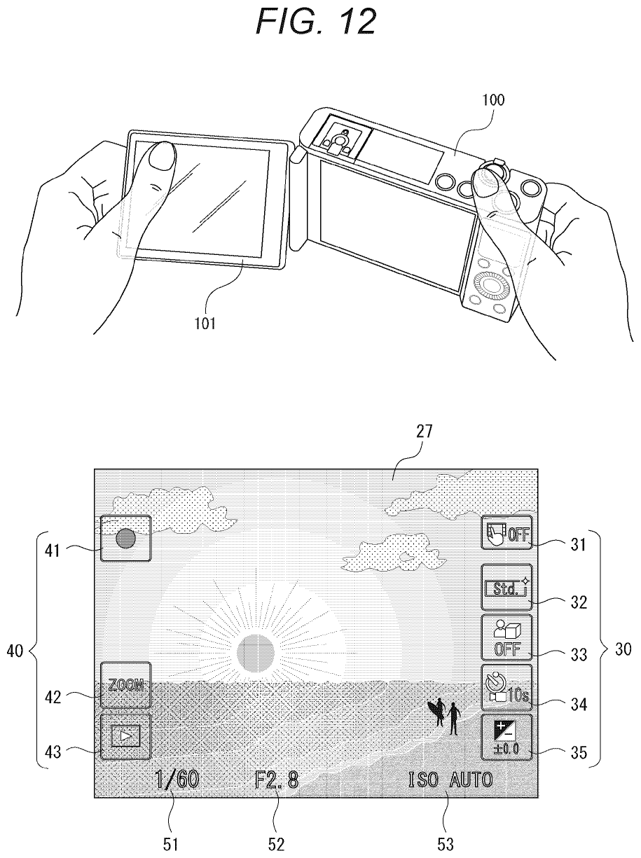

The upper part of FIG. 12 illustrates a panel-opened state. The display panel 101 is in a state where the display panel 101 is opened from the main body housing 100 of the imaging device 1.

In this case, as illustrated in the lower part of the drawing, the setting icon 30 is displayed on the right side on the screen, and the operation icon 40 is displayed on the left side on the screen.

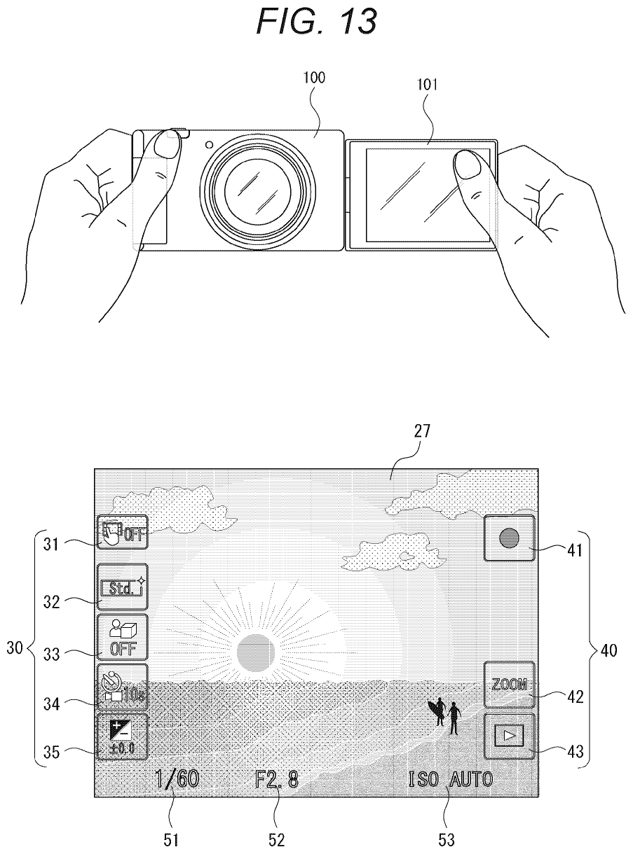

The upper part of FIG. 13 illustrates a panel-flipped state. This is a state where the screen of the display panel 101 faces forward of the main body housing 100 of the imaging device 1. This is an orientation, for example, in a case where a selfie is taken.

In this case, as illustrated in the lower part of the drawing, the setting icon 30 is displayed on the left side on the screen, and the operation icon 40 is displayed on the right side on the screen.

In a case where a selfie is taken in the panel-flipped state as illustrated in FIG. 13, it is preferable that the operation related to shooting can be performed with the right hand. Therefore, the operation icon 40 is arranged on the right side of the screen.

On the other hand, in the panel-opened state as illustrated in FIG. 12, it is difficult to operate the screen with the right hand, and the left hand is suitable for the touch operation of the screen. Therefore, the operation icon 40 is arranged on the left side of the screen.

In particular, the user operates the operation icon 40 at the right timing, which requires ease of operation. Therefore, the operation icon 40 is displayed at a position where the operation icon 40 is easy to operate on the basis of the state of the panel.

As for the panel-retracted state in FIG. 11, an example where the operation icon 40 is arranged on the right side and an example where the operation icon 40 is arranged on the left side have been described. In this panel-retracted state, the following approaches can be made.

Many hardware keys are arranged on the right side of the main body housing 100 of the imaging device 1. For example, the recording button 110R and the shutter button 110S that are hardware keys are arranged on the right side. Then, in a case where such operations are performed with the right hand, it is only required that the hardware keys be used. In a case where it is desired to operate with the left hand, it is only required that the operation icon 40 of the DTI be used. As described above, from the viewpoint of selective use based on situations, the operation icon 40 is preferably arranged on the left side.

On the other hand, there is also an approach to consolidate the recording start, the shutter operation, the zoom operation, and the like into the right hand operation regardless of the hardware key or the DTI. According to this approach, the operation icon 40 is preferably arranged on the right side.

Whether the operation icon 40 is arranged on the left side or the right side in the panel-retracted state may be determined considering a user's request or the like. Alternatively, the user may select, as desired, the left arrangement or the right arrangement in the panel-retracted state.

As described above, the layout of the setting icon 30 and the operation icon 40 is changed considering operability based on the state of the display panel 101.

The camera control unit 18 determines the generation of the display panel 101 when the DTI is enabled in step S120 in FIG. 8 described above, determines whether or not the operation icon 40 is arranged on the right side in step S121, and determines the processing in steps S122 and S123. For example, when the DTI is enabled in the state illustrated in FIG. 12, the processing in step S123 is performed, and when the DTI is disabled in the state illustrated in FIG. 13, the processing in step S122 is performed.

Furthermore, in a case where a change in orientation of the display panel 101 is detected in step S107 in FIG. 9, the camera control unit 18 determines in step S150 whether or not the orientation after the change is an orientation that requires a change of the layout of the operation icon 40, and determines in step S151 whether or not the left-right change is performed. For example, in a case where transition from the panel-flipped state illustrated in FIG. 13 to the panel-opened state illustrated in FIG. 12 is made, the layout is changed in step S151.

In step S108 in FIG. 9, the camera control unit 18 determines whether or not a function menu call operation has been performed.

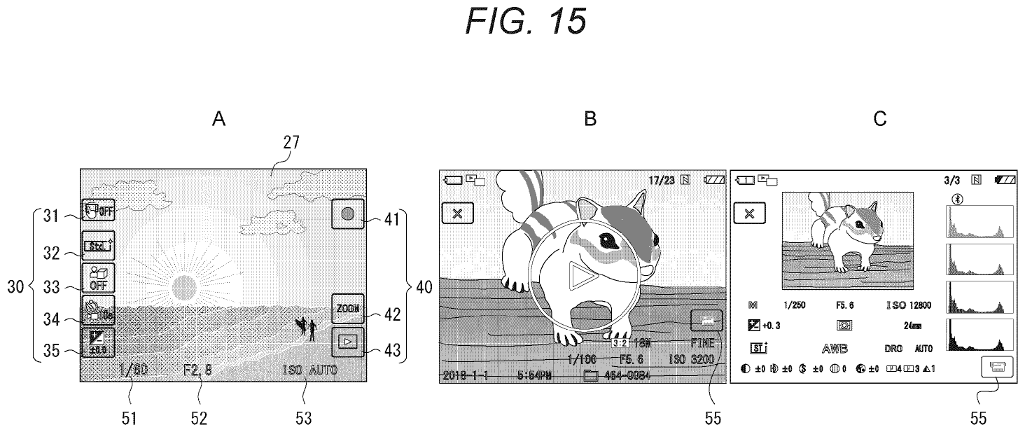

For example, FIG. 15 illustrates a swipe operation as indicated by an arrow 200. As illustrated in the drawing, regardless of the DTI ON state or the DTI OFF state, for example, a swipe operation from the lower side to the upper side of the screen is set as an operation of calling the function menu 50. It goes without saying that this is an example, and other operations may be set.

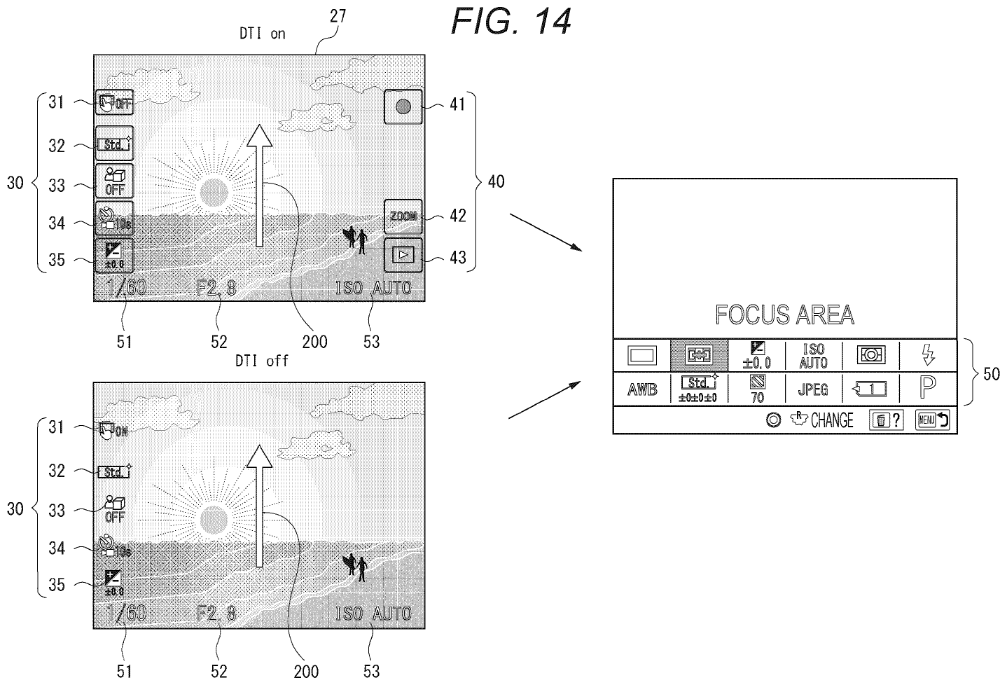

For example, in a case where the function menu call operation is detected as such a swipe operation, the camera control unit 18 proceeds to step S160 and displays the function menu 50. An example where the function menu 50 is displayed is illustrated on the right side of FIG. 14.

The function menu 50 enables the user to perform various setting operations such as a focus area setting, a PASM (P: program auto, A: diaphragm priority, S: shutter speed priority, M: manual exposure) setting, a white balance setting, an ISO speed setting, and the like. Although no detailed description will be given of individual items, the function menu 50 enables the user to perform more various setting operations that cannot be handled only by the setting icon 30.

In other words, it can be said that a setting item that is frequently switched at the time of shooting can be directly switched by the setting icon 30, and a setting item that is less-frequently switched can be handled as necessary by means of the function menu 50 prepared for such a setting item.

In step S109 in FIG. 9, the camera control unit 18 determines whether or not a function menu exit operation has been performed. In a case where the function menu exit operation is performed by a predetermined operation, the camera control unit 18 proceeds to step S161 to exit the display of the function menu 50. For example, a swipe operation of swiping the display surface of the function menu 50 from the top to the bottom may be set as the function menu exit operation.

In step S110, the camera control unit 18 monitors whether or not a setting item in the function menu 50 has been operated with the function menu 50 displayed. In a case where a certain setting item is operated, the camera control unit 18 proceeds to step S162 and performs handling processing. For example, processing such as setting switching based on the operation is performed.

The monitoring loop processing of the camera control unit 18 returns from step S110 in FIG. 9 to step S101 in FIG. 8.

Next, processing in a case where the operation of the operation icon 40 is detected in step S106 in FIG. 8 will be described with reference to FIG. 10. It is processing related to the operation of the REC button 41, the zoom entry button 42, the playback button 43, the shot mark button 44, and the shutter button 45.

In a case where the operation of the playback button 43 is detected, the camera control unit 18 proceeds from step S170 to step S180 in FIG. 10 to control a playback mode display.

Note that the modes of the imaging device 1 roughly include a shooting mode, a playback mode, and a menu mode.

The shooting mode is divided into the still image mode and the video mode, and is a mode for still image capture or video capture. On the screen of the display panel 101, a through-the-lens image is displayed as the standby state, and the DTI is also displayed as described above.

The playback mode is a mode for playback of recorded still image or recorded video, and a playback image is displayed on the screen of the display panel 101.

The menu mode is a mode in which the menu screen is displayed and the user can perform various settings.

In a case where the operation of the playback button 43 of the operation icon 40 is detected, the camera control unit 18 performs control to switch the screen display from a state of the shooting mode illustrated in FIG. 15A to a state of the playback mode illustrated in FIG. 15B or 15C in step S180.

Note that screen examples in the playback mode include a case where various icons and the like are superimposed and displayed on the playback image while the playback image is displayed on the entire screen as illustrated in FIG. 15B, and a case where various types of information are displayed while the playback image is displayed in a specific region of the screen as illustrated in FIG. 15C, and the user can select one of the screens as desired.

Although no detailed description will be given of image content and image playback in the playback mode, the user can confirm the captured still image and video on the screen in the playback mode.

Furthermore, a shooting mode button 55 is displayed on the screen in the playback mode, and the user can make transition to the shooting mode illustrated in FIG. 15A by operating the shooting mode button 55.

In a case where the shooting mode button 55 is operated on the screen in the playback mode, the camera control unit 18 proceeds from step S181 to step S182 to return to the shooting mode. The screen is also returned to the shooting mode state, that is, the state where the through-the-lens image, the DTI, and the like are displayed.

In a case where the operation of the REC button 41 of the operation icon 40 is detected, the camera control unit 18 proceeds from step S171 to step S185 in FIG. 10, to branch the processing on the basis of whether or not video recording is currently in progress. The REC button 41 is, for example, an operation element for starting video recording and functions as a recording stop button during video recording. Although not illustrated in the drawing, it is conceivable that an icon image of the REC button 41 is changed to an image indicating stop during video recording.

When video recording is not currently in progress, the camera control unit 18 proceeds to step S187 in response to the operation of the REC button 41 to perform control to start video recording processing.

When video recording is currently in progress, the camera control unit 18 proceeds to step S186 in response to the operation of the REC button 41 (the operation of the stop button) to perform control to exit the video recording processing.

The REC button 41 is displayed not only in the video mode but also in the still image mode (see FIGS. 5, 6, and 7). Therefore, in the shooting mode, the operation of the REC button 41 may be detected regardless of the video mode or the still image mode.

In a case where the operation of the shutter button 45 of the operation icon 40 is detected, the camera control unit 18 proceeds from step S172 to step S189 to control still image recording processing.

Note that the shutter button 45 is displayed, and the operation is detected only in the still image mode (see FIGS. 5, 6, and 7).

In a case where the operation of the zoom entry button 42 of the operation icon 40 is detected, the camera control unit 18 proceeds from step S173 to step S190 in FIG. 10 to control to a zoom menu display.

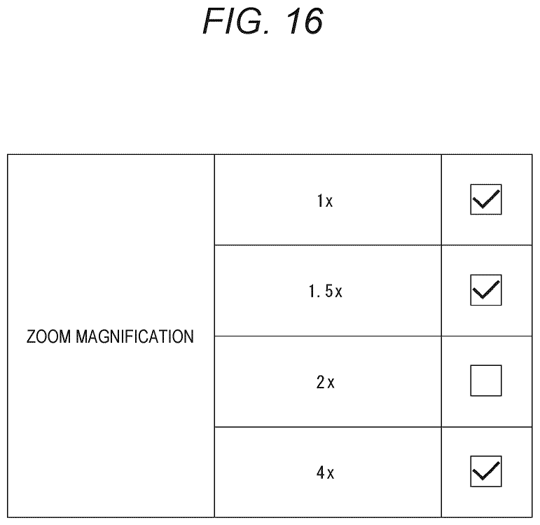

The zoom menu will be described with reference to FIGS. 16, 17, and 18.

FIG. 16 illustrates an example of a zoom magnification setting that can be selected as desired by the user. In this example, 1×, 1.5×, 2×, and 4× are offered as zoom magnifications, and the user can make each zoom magnification effective/ineffective using the corresponding checkbox.

“Effective/ineffective” given herein means whether a target zoom magnification is effective or ineffective for stepwise transition. The stepwise transition refers to transition to the target zoom magnification in response to one-touch operation as step zoom. The selection of the magnification as illustrated in FIG. 16 means that the user selects a magnification desired to be a step zoom target.

Therefore, when a certain zoom magnification is made ineffective, it means that the zoom magnification cannot be set as the step zoom target, and it does not mean that the zoom magnification cannot be made effective. For example, the zoom magnification can be made effective by operating the zoom lever 110Z or the like.

Furthermore, herein, four zoom magnifications are selectable as the step transition target, and zoom magnifications that are not selectable, such as 3× and 3.5×, are merely not to be used as the step transition target and can be set by operating the zoom lever 110Z or the like, for example.

Such zoom magnification settings based on the user's operation are stored in the memory unit 19 as zoom setting information and are sequentially updated on the basis of the operation of the checkbox. As a result, the camera control unit 18 can confirm the zoom magnifications currently selectable as the transition target when necessary.

Here, it is assumed that the checkbox is checked by the user as illustrated in the drawing, and 1×, 1.5×, and 4× are made effective as the step transition target.

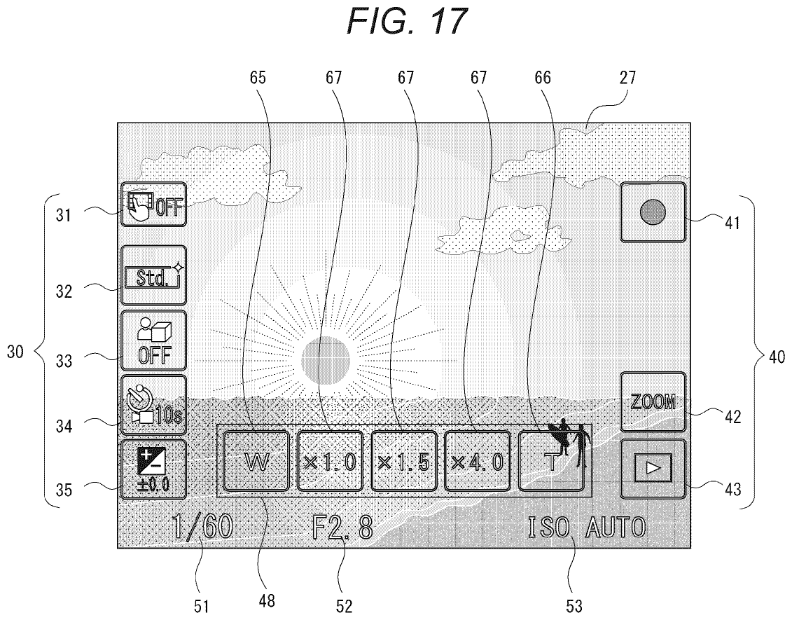

In this case, under the control of step S190, a zoom menu 48 is displayed as illustrated in FIG. 17.

In the zoom menu 48, a W button 65 and a T button 66 are arranged on the left and right, and three magnification buttons 67 are arranged between the W button 65 and the T button 66. In this case, the magnification buttons 67 correspond to 1×, 1.5×, and 4× each made effective by means of the corresponding checkbox.

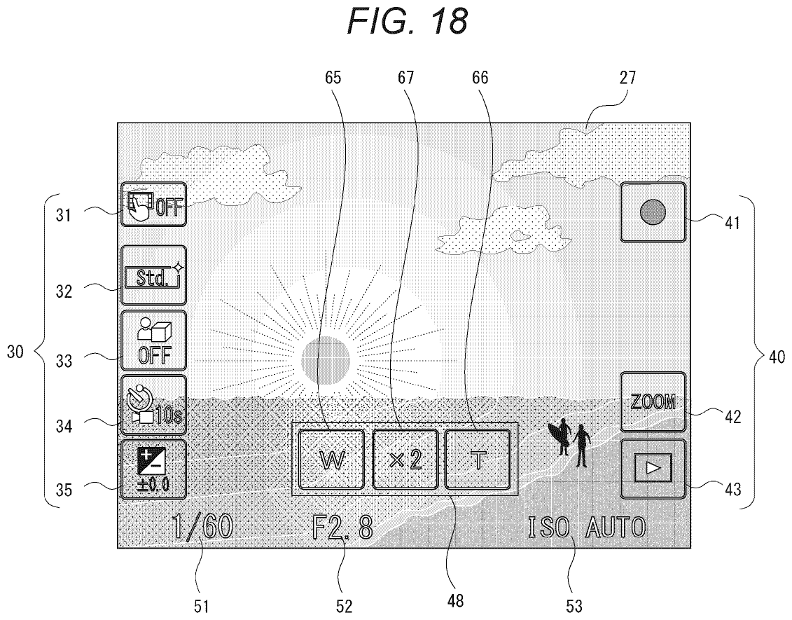

Furthermore, in a case where only 2× is made effective by means of the checkbox illustrated in FIG. 16, the magnification button 67 only corresponds to 2× as illustrated in FIG. 18.

The W button 65 is an operation element for zoom variation to the W-end side, and the T button 66 is an operation element for zoom variation to the T-end side.

Furthermore, the magnification button 67 is an operation element for zoom variation to the corresponding magnification.

Note that various possible display examples of the zoom menu 48 can be considered.

For example, the zoom menu 48 may include only the W button 65 and the T button 66.

Furthermore, the zoom menu 48 may include only one or a plurality of magnification buttons 67.

Furthermore, as for the magnification button 67, for example, the magnification button 67 of each magnification selectable in the setting illustrated in FIG. 16 may be displayed at all times, and an ineffective magnification may be displayed in a grayed-out form to indicate that the corresponding magnification button 67 is inoperable.

Furthermore, although the magnification button 67 of each effective magnification is illustrated, when the current magnification is one of the effective magnifications, the magnification button 67 of the magnification may be grayed out or removed. This is because the magnification does not change even by the operation.

For example, in a state where the zoom menu 48 is displayed as illustrated in FIGS. 17 and 18, the camera control unit 18 may perform detection in steps S174, S175, and S176 in FIG. 10.

In a case where a long-press operation of the W button 65 or the T button 66 is detected in step S174, the camera control unit 18 performs zoom variation control for the pressing period in step S191. That is, during the period where the W button 65 is pressed, the zoom magnification is changed to the W-end side at a predetermined zoom speed. Furthermore, during the period where the T button 66 is pressed, the zoom magnification is changed to the T-end side at a predetermined zoom speed.

This is an example where the W button 65 and the T button 66 can be handled in the same manner as the zoom lever 110Z that is a hardware key.

A tap operation may be performed on the W button 65 and the T button 66 separately from such an operation.

For example, in a case where the tap operation of the W button 65 or the T button 66 is detected, the camera control unit 18 proceeds from step S175 to step S192 to perform zoom processing corresponding to the tap. Specifically, in a case where the tap operation is performed on the W button 65, transition is made from the current zoom magnification to a magnification made effective as a W-end side step zoom target. In a case where the tap operation is performed on the T button 66, transition is made from the current zoom magnification to a magnification made effective as a T-end side step zoom target.

For example, in a case of the zoom menu 48 as illustrated in FIG. 17, it is assumed that the current zoom magnification is 3.5×. At this time, when the tap operation of the W button 65 is detected, the camera control unit 18 changes the zoom magnification to 1.5× in step S192, and when the tap operation of the T button 66 is detected, the zoom magnification is changed to 4×.

Note that, although the above steps S175 and S192 have been described as processing examples, the processing corresponding to the tap operation of the W button 65 and the T button 66 is not performed, and the W button 65 and the T button 66 may be handled simply as operation elements similar to the zoom lever 110Z. That is, this is an example where the zoom variation is performed at a predetermined zoom speed only during the pressing period.

In a case where the operation of the magnification button 67 is detected, the camera control unit 18 proceeds from step S176 to step S193 to perform processing of making transition to the corresponding magnification. That is, the processing corresponds to step zoom processing.

For example, in a case where the magnification button 67 of 2× is operated, the camera control unit 18 makes step transition of the zoom magnification from the current magnification to 2× in step S193.

This allows the user to extremely easily make transition for the zoom magnification selected in the setting illustrated in FIG. 16 to the target magnification by the tap operation of the magnification button 67. For example, in a case where it is desired to switch the zoom magnification between 1× and 4× during video capture, transition can be made by performing one-touch operation on the magnification buttons 67 of 1× and 4× without performing an operation of changing the zoom magnification to the target magnification using the W button 65, the T button 66, or the zoom lever 110Z. The operability becomes extremely good.

In step S177 in FIG. 10, the camera control unit 18 monitors the operation of the shot mark button 44. As illustrated in FIG. 7, the shot mark button 44 is displayed as one of the operation icons 40 during video recording. Therefore, there is a possibility that the shot mark button 44 is operated during video recording.

In a case where the operation of the shot mark button 44 is detected, the camera control unit 18 proceeds to step S194 to perform shot mark processing. For example, processing of storing a time code at the operation timing, that is, a time/minute/second/frame of the video being recorded as a shot mark point is performed. As a result, the user can easily access a scene marked with the shot mark in the video after the end of recording.

The monitoring loop processing of the camera control unit 18 returns to step S101 in FIG. 8 after step S117 in FIG. 10.

As illustrated above in FIGS. 8, 9, and 10, the DTI-related processing is performed by the camera control unit 18. This processing example is an example, and various other processing examples can be considered.

Furthermore, the types of the icons as the DTI and the operation function of displaying the icons are also examples.

As for the zoom processing, an example where the zoom variation by the W button 65 or the T button 66, that is, the zoom variation similar to the operation of the zoom lever 110Z is performed, and the zoom variation in which step transition to a specific magnification is made by one-touch operation of the magnification button 67 has described. Such zoom processing is also an example, and other examples related to the zoom processing will be described below.

### 3. Other Examples of Step Zoom

Although the example where the step zoom for transition to a specific magnification by one-touch operation is activated by the magnification button 67 of the zoom menu 48 has been described above, an example of offering simpler operability will be described below.

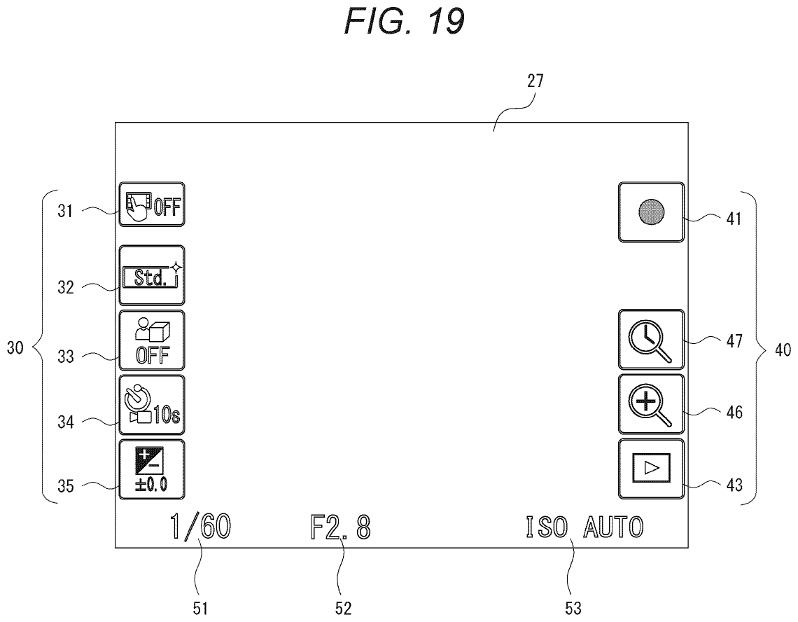

FIG. 19 illustrates a screen example in the DTI ON state. Note that, in the screen display examples in the following drawings, no description will be given of the through-the-lens image for ease of viewing of the drawings, but it should be understood that the through-the-lens image is also displayed during a period where the DTI display or the zoom variation is performed.

In the example illustrated in FIG. 19, a step zoom button 46 and an auto zoom button 47 are displayed as the operation icon 40 instead of the zoom entry button 42.

The step zoom button 46 will be described. The step zoom button 46 is an operation element for direct transition to a magnification set effective in the setting illustrated in FIG. 16 described above.

Note that, the step zoom button 46 may be displayed together with the zoom entry button 42.

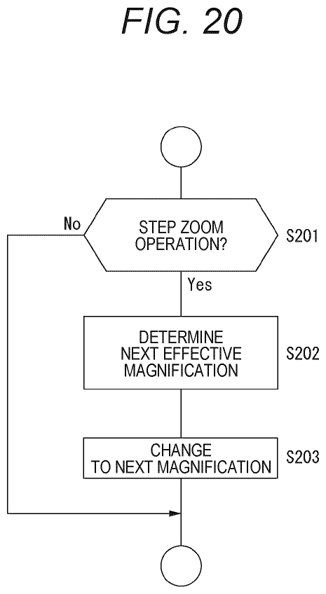

For example, instead of or in addition to the processing in steps S173 to S176 and steps S190 to S193 in FIG. 10, the processing in FIG. 20 is performed on the basis of the operation of the step zoom button 46.

In a case where the operation of the step zoom button 46 is detected, the camera control unit 18 proceeds from step S201 to step S202 in FIG. 20 to determine the next effective magnification.

Then, in step S203, the camera control unit 18 performs the zoom variation so as to change to the determined next magnification.

It is assumed that the step zoom button 46 is an operation element for sequentially changing the effective magnifications. For example, it is assumed that 1×, 1.5×, and 4× are made effective as illustrated in FIG. 16. When the current magnification is 1×, the next magnification is 1.5×.

Note that, even when the current magnification is a magnification that does not become the step transition target, such as 1.2×, the next magnification may be an effective magnification such as 1.5× that is closest to the current magnification among the higher magnifications.

In any case, every time the step zoom button 46 is operated, the effective magnification is sequentially switched in accordance with the settings.

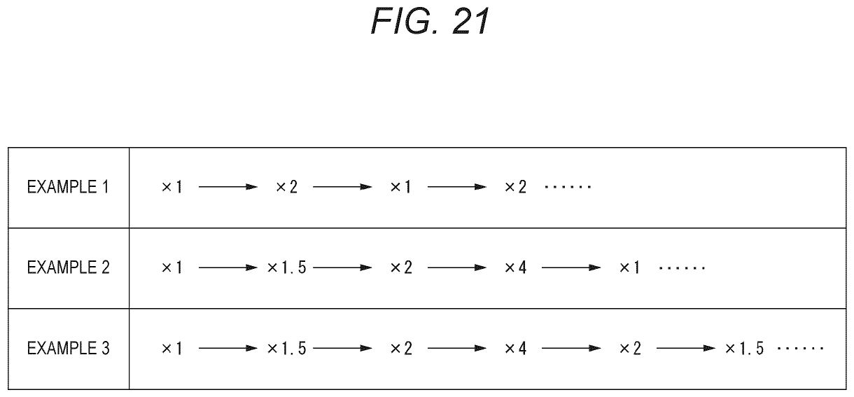

FIG. 21 illustrates an example.

Example 1 in FIG. 21 is a case where 1× and 2× are made effective as step zoom transition destinations (checked in FIG. 16). In this case, since there are only two target transition destinations, every time the step zoom button 46 is operated, the transition destination is toggled between 1× and 2×.

Example 2 in FIG. 21 is a case where four magnifications, 1×, 1.5×, 2×, and 4×, are made effective as transition destinations. In this case, every time the step zoom button 46 is operated, transition is made in the ascending order of 1×, 1.5×, 2×, and 4×. After 4×, it is assumed to return to 1×.

Example 3 in FIG. 21 is an example where four magnifications, 1×, 1.5×, 2×, and 4×, are made effective as transition destinations, but after the end of transition in ascending order, transition is made in descending order. That is, every time the step zoom button 46 is operated, transition is made in the ascending order of 1×, 1.5×, 2×, and 4×, and after reaching 4×, transition is made in the descending order of 2×, 1.5×, and 1×. After returning to 1×, transition is made in ascending order.

As described above, the target magnification selected by the user can be switched by one-touch operation using the step zoom button 46, which improves usability.

For example, for the user who alternately switches the magnification only between 1× and 4×, when 1× and 4× are made effective, the zoom operation can be performed only with the step zoom button 46 during video recording or the like. Furthermore, even in a case where it is desired to switch among three or four zoom magnifications, it is possible to perform the operation, with the step zoom button 46, of switching to the target zoom magnification more easily than the operation of the zoom lever 110Z.

### 4. Auto Zoom

Next, auto zoom will be described. The auto zoom given herein refers to zoom variation in which the zoom magnification gradually changes in response to an operation acting as a trigger. For example, the operation is an operation of gradually changing the zoom magnification with a non-continuous operation such as a tap operation or a one-push operation as a trigger, instead of gradually changing the zoom magnification during the pressing period such as the operation of the zoom lever 110Z.

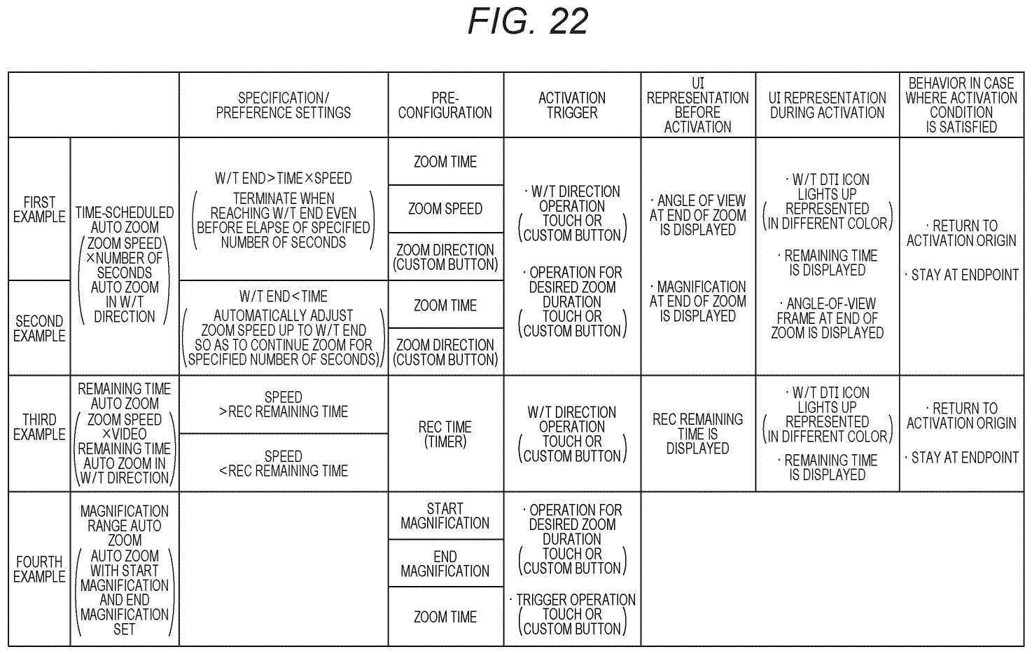

FIG. 22 illustrates an example of the auto zoom.

In the first example and the second example in FIG. 22, time (for example, the number of seconds) related to the zoom variation is specified in advance, and the zoom operation is activated, which is referred to as “time-scheduled auto zoom” for the sake of description.

In the third example, the zoom operation is performed on the basis of the remaining time of preset recording duration, which is referred to as “remaining time auto zoom” for the sake of description.

In the fourth example, the zoom operation is performed between a preset start magnification and an end magnification, which is referred to as “magnification range auto zoom” for the sake of description.

First, the time-scheduled auto zoom of the first example will be described.

In the time-scheduled auto zoom of the first example, the zoom time and the zoom speed related to the zoom variation are preset. Then, in response to a trigger operation, the zoom magnification is changed during the set zoom time at the set zoom speed in a direction to the W-end side or a direction to the T-end side.

Note that, in a case where the zoom end has been reached even before reaching the end of the set zoom time during the zoom variation, the zoom variation is terminated at that point. That is, the preset zoom time means a maximum duration during which the zoom variation is performed.

The trigger operation of activating the time-scheduled auto zoom is an operation of specifying the direction of the zoom variation. That is, the operation is to specify either the W side or the T side.

In this sense, the following example can be considered as the trigger operation.

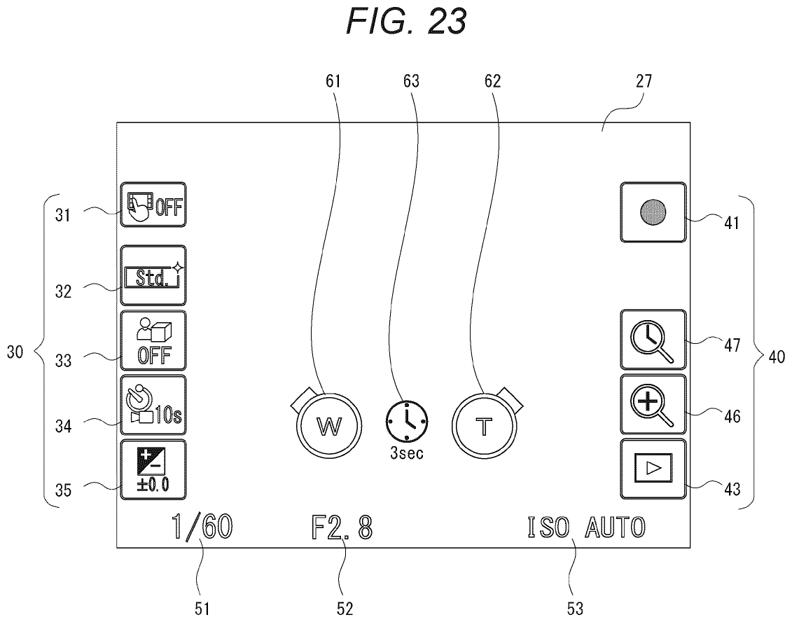

For example, in a case where it is desired to activate the time-scheduled auto zoom, the user operates the auto zoom button 47 of the operation icon 40 illustrated in FIG. 19. As a result, as illustrated in FIG. 23, a W-side auto button 61, a T-side auto button 62, and a time-scheduled auto icon 63 are displayed. In a case where such a UI is implemented, the W-side auto button 61 acts as a trigger operation element for activating the time-scheduled auto zoom to the W-end side, and the T-side auto button 62 acts as a trigger operation element for activating the time-scheduled auto zoom to the T-end side.

Furthermore, the custom buttons 110C1 and 110C2 illustrated in FIG. 1 may be set as the trigger operation element for activating the time-scheduled auto zoom to the W-end side and the trigger operation element for activating the time-scheduled auto zoom to the T-end side, respectively. Note that, in order to make the custom buttons 110C1 and 110C2 available, it is required that the operation function of the trigger operation of the time-scheduled auto zoom be preset to the custom buttons 110C1 and 110C2. For example, the custom button 110C1 is set as the W-end side trigger operation element, and the custom button 110C2 is set as the T-end side operation element.

Note that one-push operation of the zoom lever 110Z to the W side or the T side may be used as the trigger operation for activating the time-scheduled auto zoom.

Furthermore, the W button 65 and the T button 66 illustrated in FIGS. 17 and 18 may be used as the trigger operation for activating the time-scheduled auto zoom.

Furthermore, an operation of spreading and closing two fingers on the screen, a so-called pinch-in operation and pinch-out operation may be used as the trigger operation for activating the time-scheduled auto zoom to the W-end side and the T-end side.

Other trigger operation examples can also be considered. Voice operation, gesture operation, and the like may be enabled.

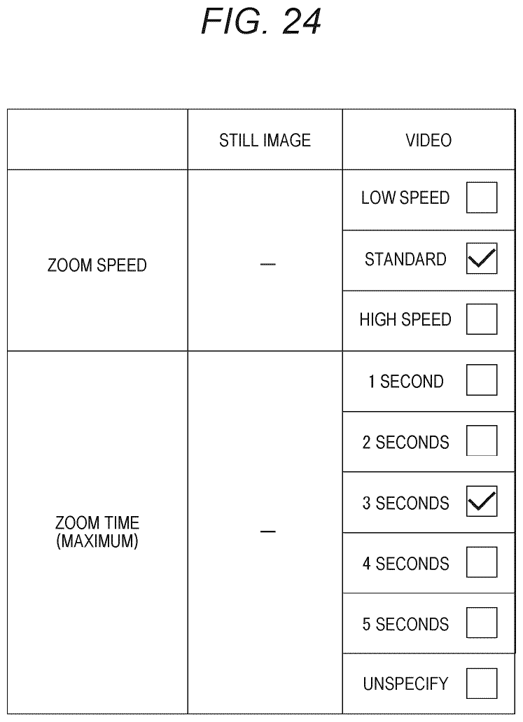

Details of the time-scheduled auto zoom as the first example will be described with reference to FIGS. 24, 25, and 26.

First, FIG. 24 illustrates an example of a setting of the zoom speed and the zoom time that can be made by the user in advance. For example, as illustrated in the drawing, “low speed”, “standard”, and “high speed” are selectively presented as the zoom speed, and the user can select a desired zoom speed by checking the corresponding checkbox.

Furthermore, “1 second”, “2 seconds”, “3 seconds”, “4 seconds”, “5 seconds”, and “not unspecified” are selectively presented as the zoom time, and the user can select a desired zoom time by checking the corresponding checkbox.

Such settings of the zoom time and the zoom speed based on the user's operation are stored as the zoom setting information in the memory unit 19, and are sequentially updated on the basis of the operation of the checkbox. As a result, the camera control unit 18 can confirm the current settings of the zoom time and the zoom speed when necessary.

After the settings are made as described above, the time-scheduled auto zoom is activated in response to the trigger operation. Now, a processing example will be described using the W-side auto button 61 and the T-side auto button 62 illustrated in FIG. 23 as an example of the trigger operation.

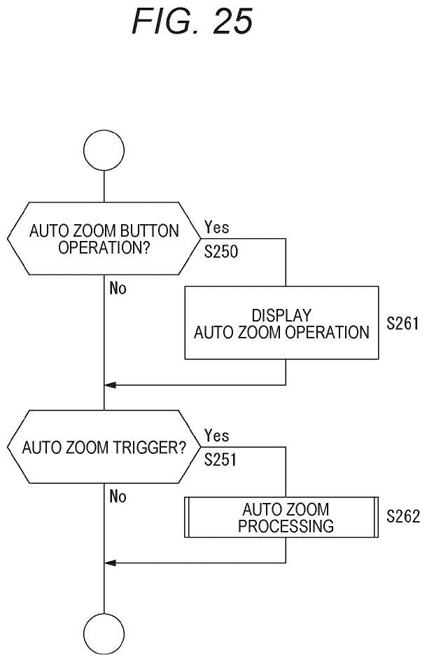

For example, processing in FIG. 25 is performed instead of or in addition to the processing in steps S173 to S176 and steps S190 to S193 in FIG. 10.

In a case where the operation of the auto zoom button 47 of the operation icon 40 is detected, the camera control unit 18 proceeds from step S250 to step S261 in FIG. 25 to perform a display to enable the auto-zoom trigger operation. That is, as illustrated in FIG. 23, the W-side auto button 61, the T-side auto button 62, and the time-scheduled auto icon 63 are displayed. With this configuration, in a case where the user desires to activate the time-scheduled auto zoom, the user can operate the W-side auto button 61 and the T-side auto button 62.

Note that the time-scheduled auto icon 63 indicates a state where the time-scheduled auto zoom can be activated, and presents the set zoom time. For example, when “3 seconds” is selected as illustrated in FIG. 24, “3 sec” is displayed as illustrated in FIG. 23. This configuration allows the user to recognize that auto zoom with a maximum duration of 3 seconds is performed by operating the W-side auto button 61 and the T-side auto button 62.

In a case where the camera control unit 18 detects the operation of the W-side auto button 61 or the T-side auto button 62 performed by the user, the camera control unit 18 proceeds from step S251 to step S262 in FIG. 25 to perform auto zoom processing.

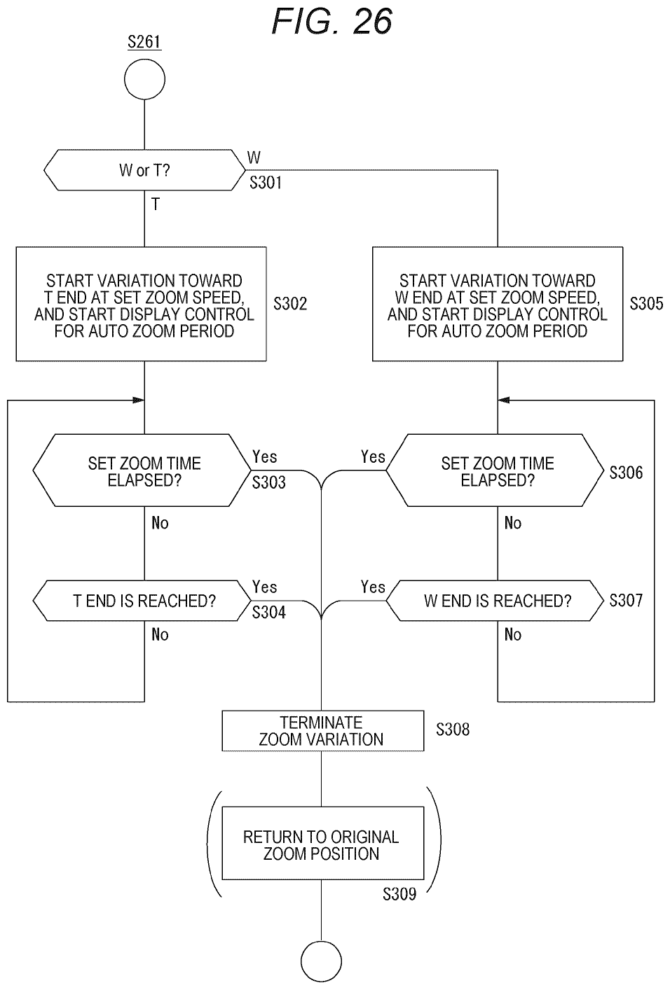

FIG. 26 illustrates details of the auto zoom processing in step S262.

In step S301, the camera control unit 18 branches the processing on the basis of whether the operation is performed on the W-side auto button 61 or the T-side auto button 62.

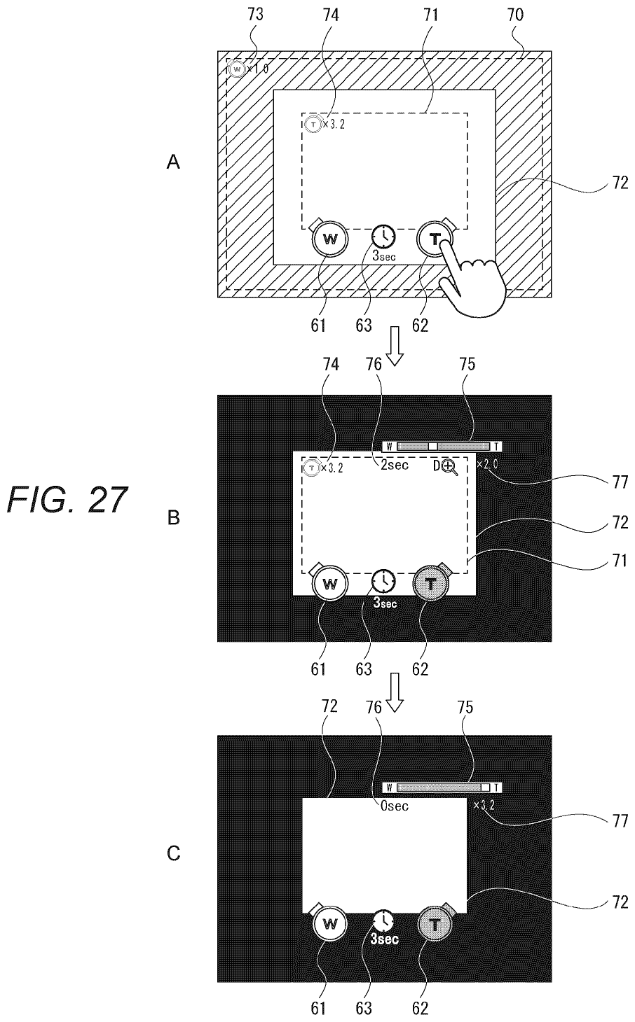

In a case where the operation of the T-side auto button 62 is detected, the camera control unit 18 proceeds to step S302 to start the zoom variation to the T-end side at the set zoom speed. Furthermore, processing of changing the display of the duration of the zoom variation by the auto zoom is also started. The display change will be described later with reference to FIG. 27.

After the start of the zoom variation to the T-end side, the camera control unit 18 monitors whether or not the set zoom time (for example, 3 seconds) has elapsed in step S303, and monitors whether or not the zoom magnification has reached the T end in step S304.

After the start of the zoom variation, in a case where the zoom time has elapsed, or in a case where the zoom magnification has reached the T-end side even before reaching the end of the zoom time, the camera control unit 18 terminates the zoom variation at that point in step S308.

Then, in step S309, the camera control unit 18 returns the zoom magnification to the original magnification and exits the processing in FIG. 26, that is, step S262 in FIG. 25. The original magnification is a magnification immediately before the start of the zoom movement in step S302.

In a case where the operation of the W-side auto button 61 is detected, the camera control unit 18 proceeds from step S301 to step S305 to start the zoom variation to the W-end side at the set zoom speed.

Furthermore, processing of changing the display of the duration of the zoom variation by the auto zoom is also started.

After the start of the zoom variation to the W-end side, the camera control unit 18 monitors whether or not the set zoom time has elapsed in step S306, and monitors whether or not the zoom magnification has reached the W end in step S307.

After the start of the zoom variation, in a case where the zoom time has elapsed, or in a case where the zoom magnification has reached the W-end side even before reaching the end of the zoom time, the camera control unit 18 terminates the zoom variation at that point in step S308. Then, in step S3098, the camera control unit 18 returns the zoom magnification to the original magnification and exits the processing in FIG. 26, that is, step S262 in FIG. 25.

With the above processing, in a case where the time-scheduled auto zoom is activated, the zoom variation to the T-end side or the W-end side is performed at the preset zoom speed. The zoom variation is performed within the preset zoom time.

Furthermore, after the end of the zoom variation, the magnification automatically returns to the original magnification.

This configuration allows the user to perform, with one-touch operation, image effects by the zoom magnification variation in which the zoom magnification gradually changes at the set zoom speed and then returns to the original zoom magnification.

Note that a processing example where, after the end of the zoom variation, the magnification is not returned to the original magnification but is maintained at the end of the zoom variation can also be considered. In this case, it is only required that the processing in step S309 in FIG. 26 be prevented from being performed.

Furthermore, FIG. 24 illustrates an example where “not specified” can be selected for the zoom time; however, in a case of “not specified”, steps S303 and S306 are skipped, and the zoom variation to the T end or the W end is performed.

Note that an example where “not specified” cannot be selected for the zoom time can also be considered.

A screen display example during activation of the time-scheduled auto zoom will be described with reference to FIG. 27.

FIG. 27A illustrates a display example where the time-scheduled auto zoom can be activated, for example. For example, it is conceivable to perform such a display as illustrated in FIG. 27A in the processing in step S261 in FIG. 25.

In this case, in addition to the W-side auto button 61, the T-side auto button 62, and the time-scheduled auto icon 63, a W-side planned angle-of-view frame 70, a T-side planned angle-of-view frame 71, a current angle-of-view frame 72, a W-side planned magnification 73, and a T-side planned magnification 74 are displayed.

The current angle-of-view frame 72 indicates an angle of view based on the current zoom magnification.

According to the time-scheduled auto zoom, the zoom variation is performed from the current angle of view (zoom magnification) to the T side or the W side for the set zoom time.

Therefore, the W-side planned angle-of-view frame 70 and the W-side planned magnification 73 are displayed to indicate an upper limit of the angle of view and an upper limit of the magnification when the time-scheduled auto zoom is activated by the W-side auto button 61.

Furthermore, the T-side planned angle-of-view frame 71 and the T-side planned magnification 74 indicate an upper limit of the angle of view and an upper limit of the magnification when the time-scheduled auto zoom is activated by the T-side auto button 62.

This configuration allows the user to recognize, before the activation, a change range of the angle of view and a change range of the magnification by the time-scheduled auto zoom.

Note that, although the through-the-lens image is not illustrated in the drawings, in a case where the current magnification (angle of view) is 1.0 or more, it is conceivable to display the through-the-lens image to the W end so that the planned angle of view in the W-end direction can also be displayed.

Furthermore, in a case where the current angle of view is an angle of view at the W end or the T end, the W-side planned angle-of-view frame 70 or the T-side planned angle-of-view frame 71 is not displayed accordingly.

Furthermore, in a case where the current angle of view is an angle of view at the W end, it is preferable to gray out the W-side auto button 61 because the zoom variation to the W-end side cannot be performed. Similarly, in a case where the current angle of view is an angle of view at the T end, the T-side auto button 62 is grayed out because the zoom variation to the T-end side cannot be performed.

FIG. 27B illustrates a display state after the time-scheduled auto zoom is activated by the T-side auto button 62, for example.

The display mode of the T-side auto button 62 is changed. For example, the color is changed to a different color. This indicates that the time-scheduled auto zoom to the T-end side is active. This active state may be expressed by not only such a color change, but also, for example, blinking of the T-side auto button 62 or the like.

Note that in a case where the time-scheduled auto zoom is activated by the W-side auto button 61, it goes without saying that the display mode of the W-side auto button 61 is changed.

Furthermore, a change in the zoom magnification to the T-end side is expressed by the current angle-of-view frame 72 gradually narrowing in accordance with the zoom variation.

Furthermore, a zoom progress bar 75, a countdown value 76, and a current magnification 77 are displayed in synchronization with the start of the zoom variation.

The zoom progress bar 75 shows the current progress of the auto zoom.

The countdown value 76 shows the remaining time of the auto zoom.

The current magnification 77 shows the current zoom magnification.

The display state of the zoom progress bar 75, the countdown value 76, and the current magnification 77 changes in a manner that depends on the progress of the zoom variation, so that the user can recognize the progress.

Furthermore, this case is an example of the zoom variation to the T-end side, and for example, a surrounding area that is a W-end side angle-of-view range relative to the current angle of view is displayed in black.

FIG. 27C illustrates the display state at the time when the time-scheduled auto zoom is terminated in step S308. The current angle-of-view frame 72 coincides with the T-side planned angle-of-view frame 71. The zoom progress bar 75, the countdown value 76, and the current magnification 77 each enter a display state corresponding to the termination.

The camera control unit 18 can also perform display control as illustrated in FIG. 26 after step S302 in FIG. 27.

The above is an example where the time-scheduled auto zoom to the T side is active, but also while the time-scheduled auto zoom to the W side is active, the display state of the zoom progress bar 75, the countdown value 76, and the current magnification 77 is similarly changed in a manner that depends on the progress of the zoom variation.

Note that, as a display example where the time-scheduled auto zoom is active, examples of the change of the display mode of the T-side auto button 62 (or the W-side auto button 61), the display of the zoom progress bar 75, the display of the countdown value 76, and the display of the current magnification 77 have been given; however, it is not necessary to display all of the elements, and only some of the elements are effective as a display indicating that the time-scheduled auto zoom is active.

Furthermore, in the above-described example, the W-side planned angle-of-view frame 70 and the T-side planned angle-of-view frame 71 are displayed in the same UI, but the W-side planned angle-of-view frame 70 and the T-side planned angle-of-view frame 71 can be provided by different UIs.

Next, the time-scheduled auto zoom given as the second example in FIG. 22 will be described.

In the time-scheduled auto zoom of the second example, the zoom time is preset as time during which the zoom variation is performed. In this example, the zoom speed is automatically adjusted such that the zoom variation is performed in the W-end side direction or the T-end side direction for the set zoom time in response to the trigger operation. That is, it can be said that it is an example where the set zoom time takes precedence.

A processing example will be described.

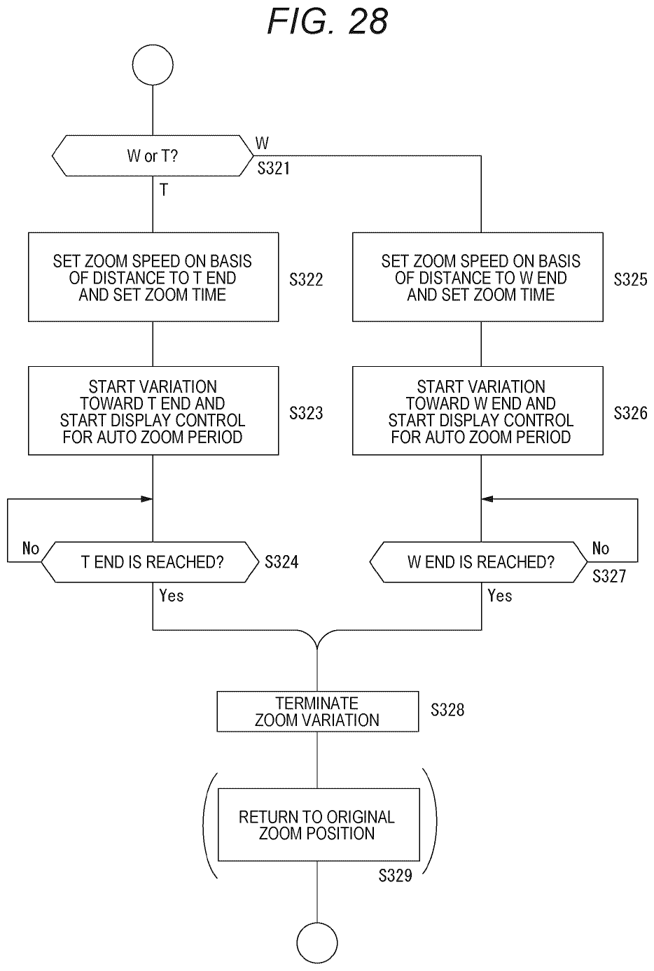

In a case where the operation of the W-side auto button 61 or the T-side auto button 62 performed by the user is detected, the camera control unit 18 proceeds from step S251 to step S262 in FIG. 25 described above to perform the auto zoom processing. In step S262, the processing in FIG. 28 is performed.

In step S321, the camera control unit 18 branches the processing on the basis of whether the operation is performed on the W-side auto button 61 or the T-side auto button 62.

In a case where the operation of the T-side auto button 62 is detected, the camera control unit 18 sets the zoom speed on the basis of a distance to the T-end side and the set zoom time in step S322. The distance to the T-end side corresponds to a difference between the current zoom magnification and the zoom magnification at the T end taken as a virtual distance. It is therefore possible to compute the zoom speed that allows the zoom variation from the current zoom magnification to the zoom magnification at the T end to be performed for the preset time.

Note that the zoom speed is obtained by using not only the distance corresponding to the zoom magnification difference between the current zoom position and the zoom end as the zoom variation distance as described above, but also a fixed zoom variation distance, that is, a distance corresponding to a fixed magnification difference.

Furthermore, in a case where the zoom time setting is “not specified”, it is conceivable to set the zoom speed to the standard zoom speed, for example. Furthermore, in a case where the second example is adopted, it is possible to make “not specified” unable to be set.

In step S323, the camera control unit 18 starts the zoom variation to the T-end side at the computed zoom speed. Furthermore, processing of changing the display of the duration of the zoom variation by the auto zoom is also started. The display change processing is, for example, the display control described with reference to FIG. 27.

After the start of the zoom variation to the T-end side, the camera control unit 18 monitors whether or not the zoom magnification has reached the T end in step S324. As the zoom speed is adjusted in step S322, the T end is reached when the set zoom time has elapsed.

After the start of the zoom variation, when the zoom magnification reaches the T-end side after the lapse of the zoom time, the camera control unit 18 terminates the zoom variation in step S328. Then, in step S329, the camera control unit 18 returns the zoom magnification to the original magnification and exits the processing in FIG. 28, that is, step S262 in FIG. 25.

In a case where the operation of the W-side auto button 61 is detected, the camera control unit 18 sets the zoom speed on the basis of the distance to the W-end side (virtual distance based on the zoom magnification difference) and the set zoom time in step S325.

In step S326, the camera control unit 18 starts the zoom variation to the W-end side at the computed zoom speed. Furthermore, processing of changing the display of the duration of the zoom variation by the auto zoom is also started.

After the start of the zoom variation to the W-end side, the camera control unit 18 monitors whether or not the zoom magnification has reached the W end in step S327.

Then, after the start of the zoom variation, when the zoom magnification reaches the W-end side after the lapse of the zoom time, the camera control unit 18 terminates the zoom variation in step S328. Then, in step S329, the camera control unit 18 returns the zoom magnification to the original magnification and exits the processing in FIG. 28.

With the above processing, in a case where the time-scheduled auto zoom is activated, the zoom variation in which the zoom magnification is gradually changed to the T side or the W side is performed for the preset zoom time.

Furthermore, after the end of the zoom variation, the magnification automatically returns to the original magnification.

This configuration allows the user to perform, with one-touch operation, image effects by the zoom magnification variation in which the zoom magnification gradually changes at a certain zoom speed and then returns to the original zoom magnification.

Note that a processing example where, after the end of the zoom variation, the magnification is not returned to the original magnification but is maintained at the end of the zoom variation can also be considered. In this case, it is only required that the processing in step S329 in FIG. 28 be prevented from being performed.

Meanwhile, in the time-scheduled auto zoom described above as the first example and the second example, the user presets the zoom time (see FIG. 24).

Here, an example of an interface for setting the zoom time in a simple manner will be described.

For example, the time-scheduled auto icon 63 is set as an operation element for changing the setting of the zoom time.

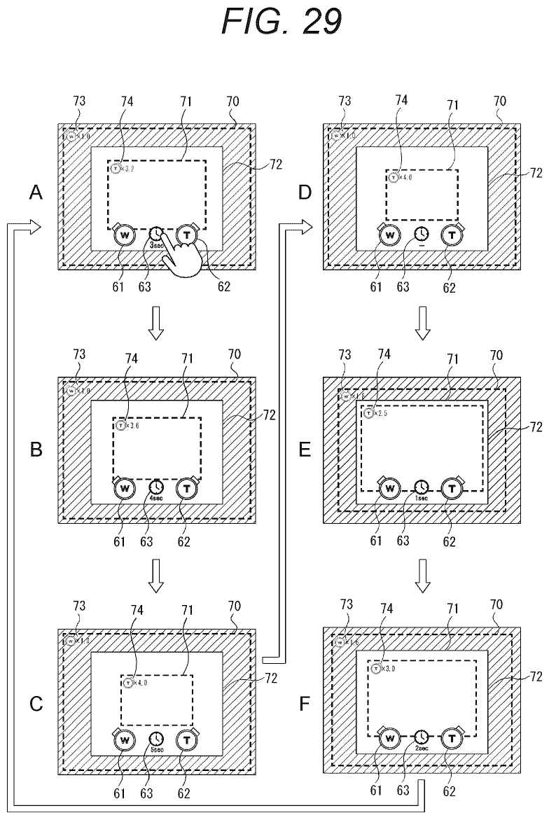

FIG. 29A illustrates a state where a tap operation is performed on the time-scheduled auto icon 63 in the display in FIG. 27A described above. It is assumed that the zoom time is set to 3 seconds.

In response to this operation, the camera control unit 18 switches the zoom time setting to 4 seconds. Furthermore, the display state is set as illustrated in FIG. 29B. That is, the display of “4 seconds” is performed on the time-scheduled auto icon 63. Furthermore, when the zoom time is changed, the zoom magnification that can be reached by the time-scheduled auto zoom is changed from the current zoom magnification (angle of view of the current angle-of-view frame 72). Therefore, the W-side planned angle-of-view frame 70, the T-side planned angle-of-view frame 71, the W-side planned magnification 73, and the T-side planned magnification 74 are updated.

Moreover, in response to the operation of the time-scheduled auto icon 63, the zoom time setting is switched in order of, for example, “5 seconds” in FIG. 29C, “not specified” in FIG. 29D, “1 second” in FIG. 29E, “2 seconds” in FIG. 29F, and “3 seconds” in FIG. 29A.

In each state, the display of the W-side planned angle-of-view frame 70, the T-side planned angle-of-view frame 71, the W-side planned magnification 73, and the T-side planned magnification 74 is updated.

It is therefore possible for the user to set, in a simple manner, the zoom time for the time-scheduled auto zoom as the first example and the second example. Furthermore, on the screen, the W-side planned angle-of-view frame 70, the T-side planned angle-of-view frame 71, and the like are updated in synchronization with the change of the zoom time setting, so that it is easy to select a desired zoom time.

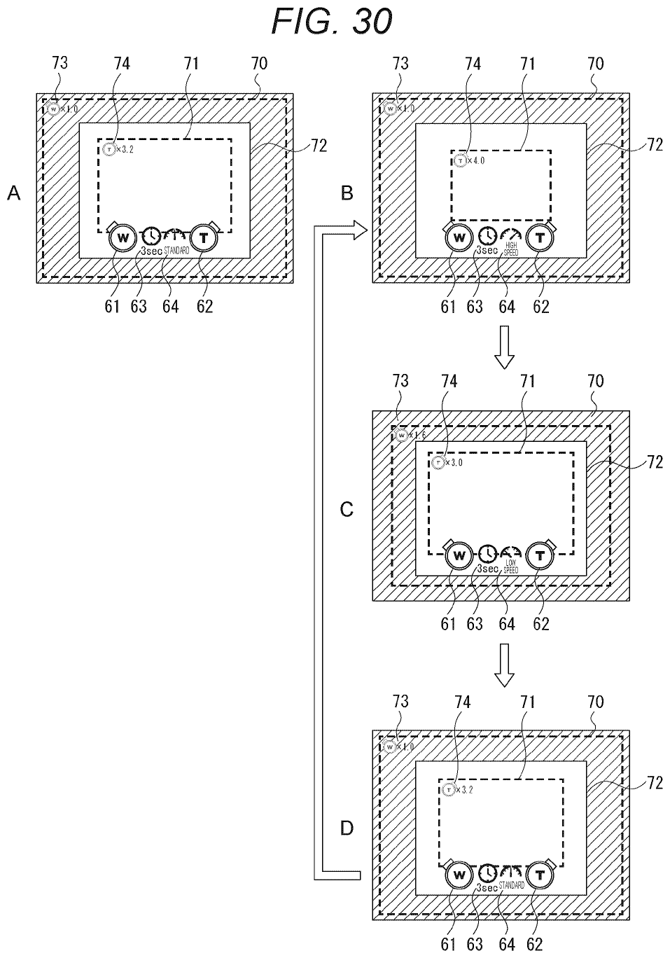

FIG. 30 illustrates an example of a UI that facilitates an additional zoom speed setting.

In the time-scheduled auto zoom as the first example, the user also presets the zoom speed. Therefore, a speed setting icon 64 is displayed as illustrated in FIG. 30A.

Then, as illustrated in FIGS. 30B, 30C, and 30D, every time the user performs a tap operation on the speed setting icon 64, the zoom speed setting is switched in the order of “high speed”, “standard”, and “low speed”.

Furthermore, in this case as well, the display of the W-side planned angle-of-view frame 70, the T-side planned angle-of-view frame 71, the W-side planned magnification 73, and the T-side planned magnification 74 is also updated on the basis of the change of the zoom speed setting.

It is therefore possible for the user to set, in a simple manner, the zoom speed for the time-scheduled auto zoom as the first example. Furthermore, on the screen, the W-side planned angle-of-view frame 70, the T-side planned angle-of-view frame 71, and the like are updated in synchronization with the change of the zoom speed setting, so that it is easy to select a desired zoom speed.

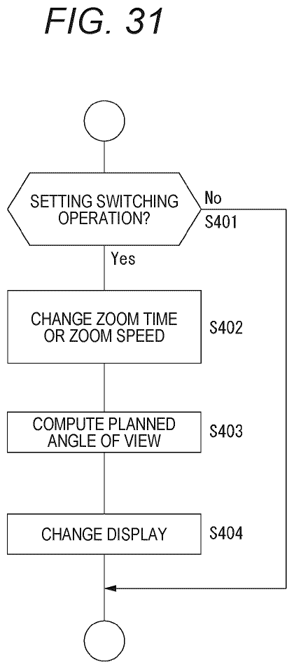

FIG. 31 illustrates a processing example in a case where the setting is changed via an interface as illustrated above in FIGS. 29 and 30.

For example, processing in FIG. 31 is added to the monitoring loop processing in FIG. 10.

In step S401, the camera control unit 18 monitors a setting switching operation. The setting switching operation given herein refers to an operation of the time-scheduled auto icon 63 or the speed setting icon 64.

In a case where the setting switching operation is detected, the camera control unit 18 proceeds to step S402 to perform processing of changing the zoom time or the zoom speed on the basis of the operation.

Furthermore, in step S403, the camera control unit 18 computes the W-end side planned angle of view and the T-end side planned angles of view on the basis of the new zoom time or zoom speed.

Then, in step S404, the camera control unit 18 performs control to update the display of the W-side planned angle-of-view frame 70, the T-side planned angle-of-view frame 71, the W-side planned magnification 73, and the T-side planned magnification 74 on the basis of the computed planned angle of view.

With the above processing, it is possible to provide the UI of the setting change operation using the time-scheduled auto icon 63 or the speed setting icon 64.

Note that the time-scheduled auto zoom described so far is activated with the operation of specifying the W-end direction or the T-end direction as a trigger, but for example, an example where an operation of specifying the zoom time such as “3 seconds” or “4 seconds” is enabled, and the zoom variation is performed in a predetermined direction (for example, only in the T-end direction) with the operation as a trigger can also be considered.

In particular, in a case where the zoom time takes precedence as in the second example, operation icons such as “3 seconds”, “4 seconds”, and “5 seconds” are displayed, so that the user can selectively perform the operation.

Moreover, operation icons such as “T side 3 seconds”, “T side 4 seconds”, “W side 3 seconds”, and “W side 4 seconds” may be displayed to enable the user to select the direction and the zoom time at the same time.

Such a case eliminates the need of the presetting of the zoom time.

Next, the remaining time auto zoom given as the third example in FIG. 22 will be described.

The remaining time auto zoom is an operation in which a video recording time is preset, and when auto zoom is activated, the zoom variation is performed for the remaining time of the video recording.

As the remaining time auto zoom, an example where the speed takes precedence during the zoom variation and an example where the video recording remaining time takes precedence during the zoom variation can be considered, and
the trigger operation is an operation of specifying the W-end direction or the T-end direction similarly to the above-described time-scheduled auto zoom.

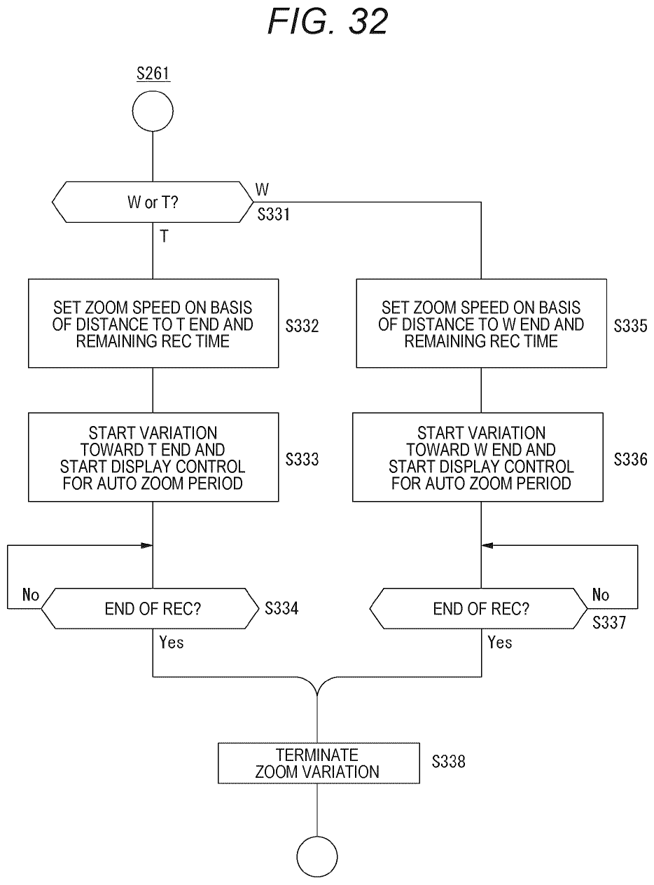

When the operation of specifying the W-end direction or the T-end direction, for example, the operation of the W-side auto button 61 or the T-side auto button 62 is detected, the camera control unit 18 performs the processing in FIG. 32.

In step S331, the camera control unit 18 branches the processing on the basis of whether the operation is performed on the W-side auto button 61 or the T-side auto button 62.

In a case where the operation of the T-side auto button 62 is detected, the camera control unit 18 sets the zoom speed on the basis of the distance to the T-end side (virtual distance based on the zoom magnification difference) and the video recording remaining time in step S332.

In step S333, the camera control unit 18 starts the zoom variation to the T-end side at the computed zoom speed. Furthermore, processing of changing the display of the duration of the zoom variation by the auto zoom is also started. The display change processing is, for example, the display mode change of the T-side auto button 62 as described in FIG. 27, and the display control of the T-side planned angle-of-view frame 71 and the T-side planned magnification 74 based on the T-side zoom magnification to be reached. It is also conceivable to perform a countdown display of the remaining time until the end of recording.

After the start of the zoom variation to the T-end side, the camera control unit 18 waits for the end of recording in step S334.

The end of recording causes the camera control unit 18 to terminate the zoom variation in step S338 and exit the processing.

In a case where the operation of the W-side auto button 61 is detected, the camera control unit 18 sets the zoom speed on the basis of the distance to the W-end side (virtual distance based on the zoom magnification difference) and the video recording remaining time in step S335.

In step S336, the camera control unit 18 starts the zoom variation to the W-end side at the computed zoom speed. Furthermore, processing of changing the display of the duration of the zoom variation by the auto zoom is also started. The display change processing is, for example, the display mode change of the W-side auto button 61, and the display control of the W-side planned angle-of-view frame 70 and the W-side planned magnification 73 based on the W-side zoom magnification to be reached. It is also conceivable to perform a countdown display of the remaining time until the end of recording.

After the start of the zoom variation to the W-end side, the camera control unit 18 waits for the end of recording in step S337.

The end of recording causes the camera control unit 18 to terminate the zoom variation in step S338 and exit the processing. Note that, at this time, the zoom magnification may be returned to the original zoom magnification.

With the above processing, in a case where the remaining time auto zoom is activated, the zoom variation in which the zoom magnification is gradually changed to the T side or the W side until the end of recording is performed for the video recording remaining time. For example, in a case where it is desired to perform the zoom variation to the T-side end at the end of the video, this can be achieved by one-touch operation.

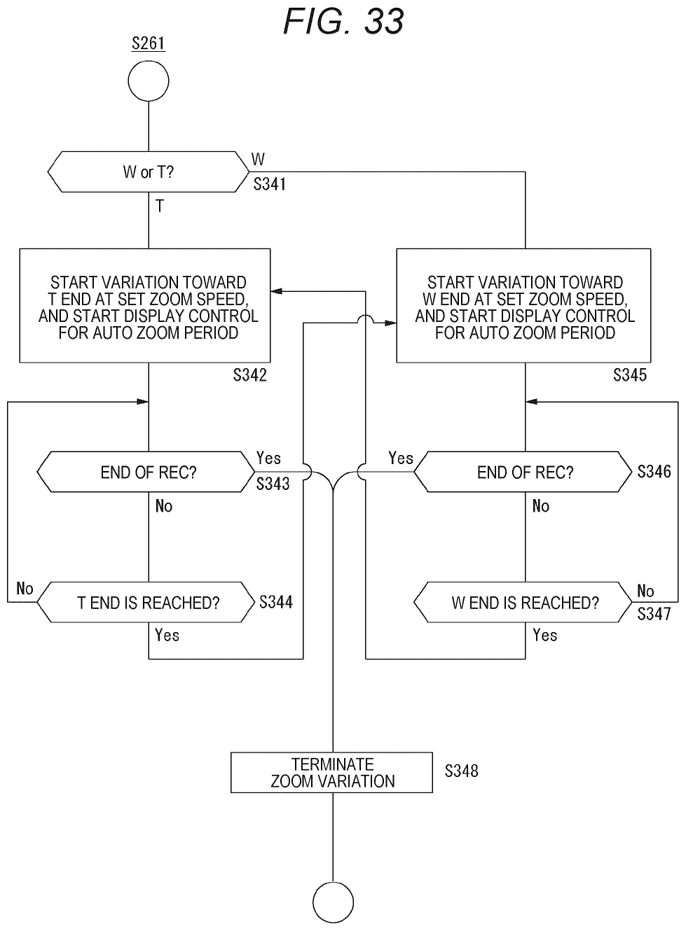

In the example in FIG. 32, the video recording remaining time takes precedence, and the zoom speed is adjusted on the basis of the remaining time, but a processing example in FIG. 33 can also be considered as an example where the zoom speed setting takes precedence.

For example, when the operation of specifying the W-end direction or the T-end direction, for example, the operation of the W-side auto button 61 or the T-side auto button 62 is detected, the camera control unit 18 performs the processing in FIG. 33.

In step S341, the camera control unit 18 branches the processing on the basis of whether the operation is performed on the W-side auto button 61 or the T-side auto button 62.

In a case where the operation of the T-side auto button 62 is detected, the camera control unit 18 starts the zoom variation to the T-end side at the preset zoom speed in step S342. Furthermore, processing of changing the display of the duration of the zoom variation by the auto zoom is also started.

After the start of the zoom variation to the T-end side, the camera control unit 18 waits for the end of recording in step S334 and monitors whether or not the T end has been reached in step S344.

When the T end has been reached, the camera control unit 18 proceeds to step S345.

In a case where the operation of the W-side auto button 61 is detected, the camera control unit 18 proceeds from step S341 to step S345 to start the zoom variation to the W-end side at the preset zoom speed. Furthermore, processing of changing the display of the duration of the zoom variation by the auto zoom is also started.

After the start of the zoom variation to the W-end side, the camera control unit 18 waits for the end of recording in step S346 and monitors whether or not the W end has been reached in step S347.

When the W end has been reached, the camera control unit 18 proceeds to step S342.

When the end of recording is detected in step S343 or step S346, the camera control unit 18 terminates the zoom variation in step S348 and exits the processing. Note that, at this time, the zoom magnification may be returned to the original zoom magnification.

With the above processing, in a case where the remaining time auto zoom is activated, the zoom variation in which the zoom magnification is gradually changed to the T-end side or the W-end side until the end of recording is performed for the video recording remaining time. In a case where the T end has been reached before the end of recording, the zoom variation to the W-end side is continuously performed. In a case where the W end has been reached before the end of recording, the zoom variation to the T-end side is continuously performed. That is, the zoom variation may be repeated between the T end and the W end until the end of recording.

The user can achieve, with one-touch operation, image effects by the zoom variation.

Next, the magnification range auto zoom given as a fourth example in FIG. 22 will be described.

In the magnification range auto zoom, the start magnification and the end magnification are set, and zoom variation from the start operation to the end magnification is performed in response to a trigger operation.

Note that, as the trigger operation, only the trigger for the activation of the magnification range auto zoom may be used, but for example, the operation of specifying the zoom time may be performed as the trigger operation. For example, an icon acting as the trigger operation such as “3 seconds”, “4 seconds”, or “5 seconds” is displayed, and when the user specifies the zoom time, the magnification range auto zoom is activated.

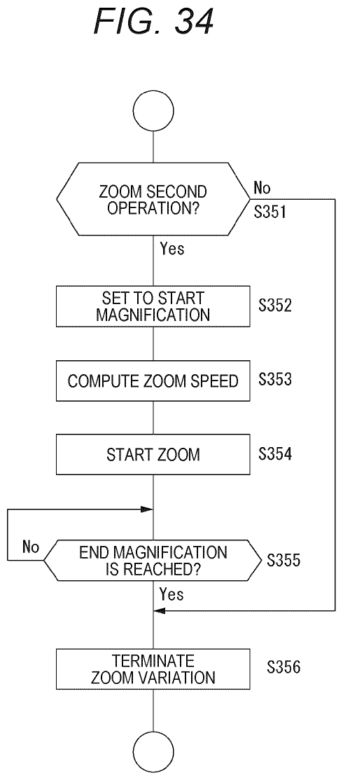

A processing example in such a case is illustrated in FIG. 34. For example, in response to the operation of the icon indicating “3 seconds”, “4 seconds”, “5 seconds”, or the like, the camera control unit 18 proceeds from step S351 to step S352, and first sets the zoom state to the preset start magnification. That is, if the current zoom magnification is not the set start magnification, the zoom variation to the start magnification is performed. Alternatively, the start magnification need not be preset, and a magnification at the time of the trigger operation may be used as the start magnification.

In step S352, the camera control unit 18 computes the zoom speed on the basis of the virtual distance based on a difference between the start magnification and the end magnification and the zoom time specified by the operation.

In step S353, the camera control unit 18 starts the zoom variation to the end magnification at the computed zoom speed.

The camera control unit 18 monitors whether or not the end magnification has been reached in step S355 and terminates the zoom variation in step S356 when the end magnification has been reached.

As described above, the user can perform, by presetting the start magnification and the end magnification, the zoom variation from the start magnification to the end magnification with one-touch operation. Furthermore, the zoom operation can also be performed at a desired zoom speed by the operation of specifying the zoom time such as “3 seconds”, “4 seconds”, or “5 seconds”.

Note that the zoom time and the zoom speed may be preset. In this case, for example, it is conceivable that the magnification range auto zoom is activated by the auto zoom button 47 or the like in FIG. 19, and the zoom variation from the start magnification to the end magnification is performed at the preset zoom time or zoom speed.

Meanwhile, in each example as the time-scheduled auto zoom (first example and second example), the remaining time auto zoom (third example), and the magnification range auto zoom (fourth example) described above, the UI for presetting the zoom time and the zoom speed and facilitating the change of such settings has been described with reference to FIGS. 29 and 30.

As for the auto zoom, it is also conceivable to set a zoom magnification, for example, a target zoom magnification to be a zoom variation target instead of or together with the zoom time and the zoom speed. For example, it is also possible to implement auto zoom in which the zoom variation continues until the target zoom magnification is reached.

Note that the target zoom magnification may mean, for example, the end magnification described in the fourth example, or may indicate a zoom magnification to be reached, that is, a variation in magnification from the current magnification, for example, “twice the current magnification”.

Therefore, an example of a UI for setting the zoom magnification will also be described.

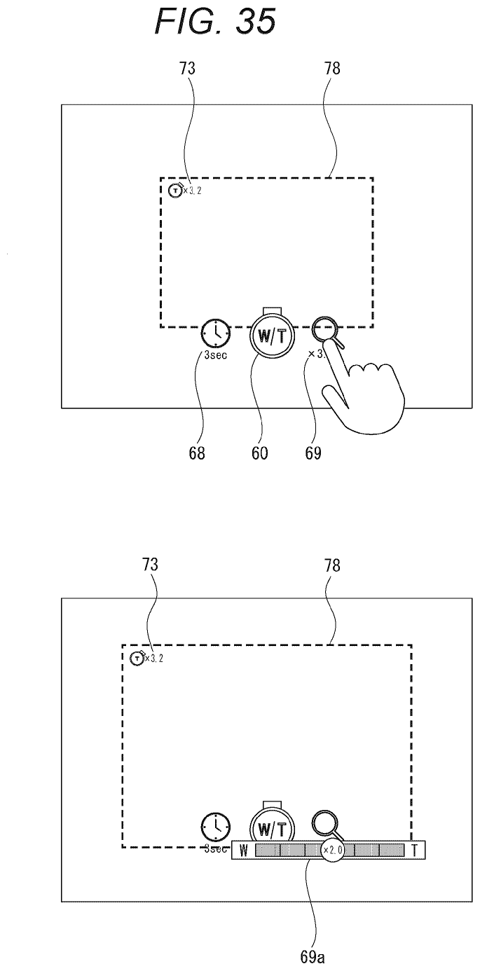

FIG. 35A illustrates an example where a W/T button 60, a time setting icon 68, and a magnification setting icon 69 are displayed.

For example, a target zoom magnification (for example, end magnification) to be an auto zoom target is displayed by the magnification setting icon 69. In this example, it is 3.2×. Furthermore, a magnification setting frame 78 indicates an angle-of-view range at the set magnification.

In order to change such a magnification setting, for example, the user operates the magnification setting icon 69. In response to the operation, for example, as illustrated in FIG. 35B, a magnification bar 69a is displayed, so as to allow the target zoom magnification to be specified by tapping on the bar. Furthermore, at this time, the magnification setting frame 78 is also updated in response to the tap. A mark indicating the magnification displayed together with the magnification setting frame 78 may be switched on the basis of whether the magnification is close to the T side or the W side relative to the current magnification.

Such an interface allows the user to easily set the target zoom magnification of the auto zoom.

Note that, in a manner similar to the time-scheduled auto icon 63 in FIG. 29, the time setting icon 68 in FIG. 35A can be used as an icon for switching the target zoom time set in response to the tap operation.

Furthermore, it is conceivable that the W/T button 60 is used as an operation element for activating the auto zoom with the set target zoom magnification as a target.

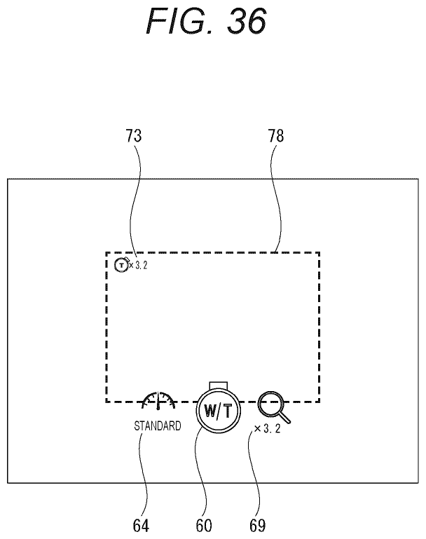

FIG. 36 illustrates an example where the W/T button 60, the speed setting icon 64, and the magnification setting icon 69 are displayed. The magnification setting icon 69 is similar to the magnification setting icon 69 in FIGS. 35A and 35B.

The speed setting icon 64 allows the zoom speed setting to be switched as described with reference to FIG. 30.

Note that, as the UI, there may be a pattern where “zoom time”, “zoom speed”, and “target zoom magnification” are handled in parallel and set. Note that a product of two values is used, so that it is necessary to take a measure against the UI that allows three options to be selected in parallel, such as making the most recently changed two values effective and graying out the remaining one value.

### 5. Conclusion and Modifications

According to the above-described embodiments, the following effects can be obtained.

The imaging device 1 of the embodiment includes the memory unit 19 as a storage unit that stores zoom setting information set by operation. The zoom setting information includes at least one of a zoom time, a zoom speed, or a target zoom magnification. Furthermore, the imaging device 1 includes the camera control unit 18 that performs, on the basis of a first operation acting as a trigger for starting zoom variation that causes a zoom magnification to change to a wide-end side or a tele-end side, the zoom variation reflecting the zoom setting information.

For example, time-scheduled auto zoom can be performed. In a case of video shooting such as a video blog, the zoom variation operation reflecting the zoom time set by one-touch operation is performed. It is therefore possible to perform video shooting using the zoom function in a simpler manner. Furthermore, it is also convenient for a case where complicated operations cannot be performed such as selfie.

As the auto zoom, not only the time-scheduled auto zoom but also the auto zoom reflecting the zoom speed, the auto zoom reflecting the target zoom magnification, and the like can be performed, all of which are convenient functions.

Note that the first operation is an operation acting as a trigger for the auto zoom such as the time-scheduled auto zoom, and includes, as described above, operation of the W-side auto button 61/T-side auto button 62, operation of the custom buttons 110C1 or 110C2, one-push operation of the zoom lever 110Z to the W side or the T side, operation of the W button 65/T button 66, pinch-in/pinch-out operation, and the like.

In the time-scheduled auto zoom (first example) of the embodiment, an example where the set zoom time is a maximum duration for the zoom variation, the zoom setting information includes the zoom speed, and the camera control unit 18 performs control to start the zoom variation at the set zoom speed on the basis of the operation (first operation) acting as a trigger has been described (see FIG. 26).

With this configuration, it is possible to perform the auto zoom at the preset zoom speed by one-touch operation such as a touch operation or a custom button operation. It is possible to obtain, by specifying the zoom speed, a zoom effect with a speed according to the user's video creation intention.

In the time-scheduled auto zoom (first example) of the embodiment, an example where the camera control unit 18 performs control to perform the zoom variation at the set zoom speed within a range not exceeding the set zoom time has been described (see FIG. 26).

Since the maximum duration during which the zoom movement is performed can be determined with precedence given to the present zoom speed, the duration of the zoom variation is never longer than intended by the user. With this configuration, it is possible to easily activate the zoom operation that is felt to be appropriate in video presentation.

Note that, in a case where the zoom end (the W end or the T end) is reached before the end of the zoom time, it is only required that the zoom variation be terminated at that point. With this configuration, it is possible to perform the zoom variation within a range not exceeding the zoom time.

Note that, in a case where the zoom end is reached and the time still remains, it is also conceivable to further move in the opposite direction at the same zoom speed. With such a configuration, it is possible to implement an auto zoom operation in which the zoom variation is performed for the set zoom time.

In the time-scheduled auto zoom (second example) of the embodiment, an example where the set zoom time is a zoom movement duration, and the camera control unit 18 obtains the zoom speed from the zoom variation distance and the zoom time and performs control to start the zoom variation at the obtained zoom speed on the basis of the operation (first operation) acting as a trigger has been described (see FIG. 28).

With this configuration, it is possible perform, by presetting the zoom time, the auto zoom for the zoom time with one-touch operation such as a touch operation or a custom button operation. It is therefore possible to obtain image effects as a result of the zoom variation performed for a time according to the user's video creation intention.

In the time-scheduled auto zoom (second example) of the embodiment, an example where the camera control unit 18 obtains the zoom speed on the basis of a distance corresponding to the zoom magnification difference between the current zoom position to the zoom end as the zoom variation distance on the basis of the operation (first operation) acting as a trigger has been described (see FIG. 28).

With this configuration, zoom to the zoom end (W end or T end) is performed for the preset zoom time. The user can perform such auto zoom with one-touch operation such as a touch operation or a custom button operation.

In the embodiment, an example where the camera control unit 18 performs control to display an operation element for specifying the wide side and the tele side on the display unit 15, and either a wide-side operation or a tele-side operation is set as the operation (first operation) acting as a trigger for the time-scheduled auto zoom has been described.

For example, the W-side auto button 61 and the T-side auto button 62 in FIG. 22 are displayed as operation elements for specifying the W-end side and the T-end side in the time-scheduled auto zoom, so that it is possible to provide an auto zoom operation that a user accustomed to touch operations on display screens can intuitively perform.

In the embodiment, an example where the imaging device 1 includes a hardware operation element that is operation-configurable, and in a case where the wide-size auto zoom operation or the tele-side auto zoom operation is assigned to the hardware operation element, the camera control unit 18 uses the hardware operation element as an operation (first operation) specifying either the wide side or the tele side and acting as the trigger for the time-scheduled auto zoom has been described.

For example, the W-side time-scheduled auto zoom and the T-side time-scheduled auto zoom are assigned to the custom buttons 110C1 and 110C2, respectively. With this configuration, it is possible to perform the time-scheduled auto zoom operation using such a hardware operation element. This is suitable for a user who is accustomed to hardware operation elements.

In the embodiment, an example where the camera control unit 18 performs control to perform a display indicating the planned angle of view at the end of the zoom variation in a case where the zoom variation is performed on the basis of the time-scheduled auto zoom has been described.

For example, the W-side planned angle-of-view frame 70 and the T-side planned angle-of-view frame 71 in FIG. 27A are displayed. This configuration allows the user to know how the angle of view will be changed as a result of the zoom variation based on the time-scheduled auto zoom before the operation. Furthermore, it is therefore possible to take measures such as adjusting the angle of view before the time-scheduled auto zoom operation.

In the embodiment, an example where the camera control unit 18 performs control to perform a display indicating the zoom variation status during a period where the zoom variation based on the time-scheduled auto zoom is performed has been described.

For example, the progress of the zoom variation is indicated by the zoom progress bar 75 in FIGS. 27B and 27C, the remaining time is indicated by the countdown value 76, and the current zoom magnification is indicated by the current magnification 77. This configuration allows the user to confirm the zoom variation status during the time-scheduled auto zoom.

In the embodiment, an example where the camera control unit 18 controls a display indicating that the zoom variation is in progress during a period where the zoom variation based on the time-scheduled auto zoom is performed has been described.

For example, in the examples in FIGS. 27B and 27C, the display mode of the T-side auto button 62 is changed (for example, the color is changed) to indicate that the time-scheduled auto zoom to the T side is in progress. When the time-scheduled auto zoom to the W side is in progress, the display mode of the W-side auto button 61 is changed. This configuration allows the user to recognize on the screen that the time-scheduled auto zoom is in progress.

In the embodiment, an example where the camera control unit 18 performs display control of the time icon indicating the zoom time included in the zoom setting information and performs processing of changing the zoom time setting on the basis of the operation of the time icon has been described.

For example, as illustrated in FIGS. 23 and 27A, the time-scheduled auto icon 63 is displayed. The time-scheduled auto icon 63 clearly indicates the set zoom time. This configuration allows the user to know the currently set zoom time.

Furthermore, as described with reference to FIGS. 29 and 31, it is possible to change the zoom time setting using the time-scheduled auto icon 63 as an operation element. This configuration allows the user to easily select the zoom time for the time-scheduled auto zoom with an intuitive operation.

In the embodiment, an example where the camera control unit 18 performs control to perform a display indicating the planned angle of view at the end of the zoom variation in a case where the zoom variation based on the time-scheduled auto zoom is performed, and performs control to change the display indicating the planned angle of view at the end of the zoom variation in response to the processing of changing the zoom time setting has been described.

For example, the W-side planned angle-of-view frame 70 and the T-side planned angle-of-view frame 71 in FIG. 26A are displayed, but as described with reference to FIGS. 29 and 31, when the zoom time setting has been changed, the display of the W-side planned angle-of-view frame 70 and the T-side planned angle-of-view frame 71 is updated accordingly. This configuration allows the user to recognize the state of the angle of view reflecting to the setting change after the end of the zoom variation based on the time-scheduled auto zoom.

In the embodiment, an example where the zoom setting information includes a setting indicating that a plurality of zoom magnifications is set effective, and the camera control unit 18 controls step zoom to perform a zoom movement action to transition to another zoom magnification set effective on the basis of a second operation of instructing switching among the zoom magnifications set effective has been described.

For example, it is assumed that the zoom magnifications can be selected as illustrated in FIG. 16. Then, as illustrated in FIGS. 20 and 21, switching among the set zoom magnifications can be performed as step zoom. This configuration allows the user to perform the switching among the zoom magnifications set effective in advance as transition destinations with one-touch operation.

In the embodiment, an example where the camera control unit 18 causes the display unit 15 to display a magnification operation element associated with each of the plurality of zoom magnifications set effective, and sets an operation of the magnification operation element as the second operation of instructing switching among the plurality of set zoom magnifications has been described.

For example, as illustrated in FIGS. 17 and 18, the magnification button 67 is displayed as each operation element associated with the corresponding zoom magnification. Then, the operation of the magnification button 67 causes direct transition to the corresponding zoom magnification. This configuration makes it convenient for a use case where it is desired to make transition among set zoom magnifications.

In the embodiment, an example where the camera control unit 18 causes the display unit 15 to display a switching operation element for instructing the switching among the plurality of zoom magnifications set effective, and sets an operation of the switching operation element as the second operation of instructing the switching among the plurality of zoom magnifications set effective has been described.

For example, operation elements for instructing switching among magnifications are displayed, such as the W button 65 and the T button 66 in FIGS. 17 and 18 or the step zoom button 46 in FIG. 19. Then, the zoom state is controlled to transition to the next magnification among the set magnifications on the basis of the operation of each of the operation elements. This configuration also makes it convenient for a use case where it is desired to cause the zoom state to transition among the set magnifications. In particular, in a case where two zoom magnifications are set effective, the two magnifications are alternately switched on the basis of the operation of the step zoom button 46, which improves usability. Furthermore, in a case where three or more zoom magnifications are set effective, the zoom magnifications are sequentially switched, which is user-friendly (see FIG. 21).

In the embodiment, an example where the camera control unit 18 performs control to cause the display unit 15 to display, as touch-enabled icons, the setting icon 30 indicating a setting state and capable of performing a setting change operation, and the operation icon 40 for instructing the imaging device 1 to operate has been described.

For example, as illustrated in FIG. 3, touch-enabled icons are displayed as the setting icon 30 and the operation icon 40. In particular, frequently-used operations are assigned to the setting icon 30 and the operation icon 40. With this configuration, an intuitive user interface is provided for a user accustomed to touch operations.

In the embodiment, an example where the camera control unit 18 performs control to cause the setting icon 30 and the operation icon 40 to appear during the DTI ON period where the icon-touch operation function is enabled, and to cause the setting icon 30 to appear and cause the operation icon 40 to disappear during the DTI OFF period where the icon-touch operation function is disabled has been described.

The DTI operation can be enabled/disabled as desired by the user, but the setting icon 30 is displayed regardless of whether the DTI is enabled or disabled since the setting icon 30 has a role of clearly indicating the setting state. On the other hand, the operation icon 40 is not displayed when the DTI is disabled. This configuration prevents the screen from being more complicated than necessary.

In the embodiment, as the display unit 15, a display unit 15 capable of changing an orientation relative to the main body housing 100 of the imaging device 1 is provided. That is, the display unit 15 is disposed on the display panel 101. Then, an example where the camera control unit 18 performs control to change the display positions of the setting icon 30 and the operation icon 40 in the screen on the basis of the orientation state of the display panel 101 has been described.

For example, as illustrated in FIGS. 11, 12, and 13, the left and right arrangement of the setting icon 30 and the operation icon 40 is controlled. This configuration allows the operation icon 40 to be easily touched in accordance with the user's shooting condition.

In the embodiment, an example where the operation icon 40 includes an icon acting as an operation element of the trigger operation (first operation) for the time-scheduled auto zoom or an icon acting as an operation element for calling the icon acting as the operation element of the first operation has been described.

For example, the auto zoom button 47 in FIG. 19 may be set as an operation element of the first operation to the T side, for example. A T-side auto zoom button and a W-side auto zoom button may be provided.

Alternatively, as in the above-described example, the W-side auto button 61 or the T-side auto button 62 called by the auto zoom button 47 is set as the operation element of the first operation. The W button 65 and the T button 66 in FIGS. 17 and 18 may be set as the operation element of the first operation. The time-scheduled auto zoom is activated by such operation elements. With this configuration, it is possible to implement the time-scheduled auto zoom operation using an icon as the DTI.

A program of the embodiment is a program for causing a processor such as a CPU or a DSP, or a device including the processor to perform the processing of the camera control unit 18 described above.

That is, the program of the embodiment is a program for causing an information processing device such as a processor in the imaging device 1 to perform processing of controlling, on the basis of a first operation acting as a trigger for starting zoom variation that causes a zoom magnification to change to a wide-end side or a tele-end side, the zoom variation reflecting the zoom time included in the zoom setting information.

With such a program, the camera control unit 18 of the imaging device 1 that performs the operation as the above-described time-scheduled auto zoom can be implemented by a processor such as a CPU and a DSP.

Such a program can be recorded in advance in an HDD as a recording medium built in a device such as a computer device, a ROM in a microcomputer having a CPU, or the like. Furthermore, such a program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program may be installed from the removable recording medium into a personal computer and the like, or may be downloaded from a download site through a network such as a local area network (LAN) or the Internet.

Furthermore, such a program is suitable for providing the imaging device 1 of the embodiment in a wide range. For example, downloading the program to a personal computer, a communication device, a portable terminal device such as a smartphone or a tablet, a mobile phone, a gaming console, or the like allows such devices to function as the imaging device 1 of the present disclosure.

Note that the effects described in the present specification are merely examples and are not limited, and other effects may be exerted.

Note that, the present technology may also have the following configurations.

(1)

An imaging device including:
a storage unit configured to store zoom setting information that is set by an operation and includes at least one of a zoom time, a zoom speed, or a target zoom magnification; and
a control unit configured to perform, on the basis of a first operation acting as a trigger for starting zoom variation that causes a zoom magnification to change to a wide-end side or a tele-end side, the zoom variation reflecting the zoom setting information.

(2)

The imaging device according to the above (1), in which
the zoom setting information includes the zoom time and the zoom speed,
the zoom time indicates a maximum duration during which the zoom variation is performed, and
the control unit performs control to start the zoom variation at the zoom speed on the basis of the first operation.

(3)

The imaging device according to the above (2), in which
the control unit performs control to perform the zoom variation at the zoom speed within a range not exceeding the zoom time.

(4)

The imaging device according to the above 1, in which
the zoom setting information includes the zoom time,
the zoom time indicates a duration during which the zoom variation is performed, and
the control unit obtains the zoom speed from a zoom variation distance and the zoom time and performs control to start the zoom variation at the zoom speed that has been obtained on the basis of the first operation.

(5)

The imaging device according to the above (4), in which
the control unit obtains the zoom speed using a distance corresponding to a zoom magnification difference between a current zoom position to a zoom end as the zoom variation distance on the basis of the first operation.

(6)

The imaging device according to any one of the above (1) to (5), in which
the control unit performs control to cause a display unit to display an operation element configured to specify a wide side or a tele side and sets a wide-side operation or a tele-side operation via the operation element as the first operation.

(7)

The imaging device according to any one of the above (1) to (6), further including
a hardware operation element that is operation-configurable, in which
in a case where a wide-side auto zoom operation or a tele-side auto zoom operation is assigned to the hardware operation element, the control unit sets the hardware operation element as the first operation of specifying either the wide side or the tele side.

(8)

The imaging device according to any one of the above (1) to (7), in which,
in a case where the zoom variation based on the first operation is performed, the control unit performs control to perform a display indicating a planned angle of view at the end of the zoom variation.

(9)

The imaging device according to any one of the above (1) to (8), in which
the control unit
performs control to perform a display indicating a zoom variation status during a period where the zoom variation based on the first operation is in progress.

(10)

The imaging device according to any one of the above (1) to (9), in which
the control unit
controls, during a period where the zoom variation based on the first operation is in progress, a display indicating that the zoom variation is in progress.

(11)

The imaging device according to any one of the above (1) to (10), in which
the zoom setting information includes the zoom time, and
the control unit
performs display control of a time icon indicating the zoom time included in the zoom setting information, and
further performs processing of changing a setting of the zoom time on the basis of an operation of the time icon.

(12)

The imaging device according to any one of the above (1) to (11), in which
the zoom setting information includes the zoom time, and
in a case where the zoom variation based on the first operation is performed, the control unit performs control to perform a display indicating a planned angle of view at the end of the zoom variation, and
further performs control to change the display indicating the planned angle of view at the end of the zoom variation in response to processing of changing a setting of the zoom time.

(13)

The imaging device according to any one of the above (1) to (12), in which
the zoom setting information includes a setting indicating that a plurality of the zoom magnifications is set effective, and
the control unit performs control to perform a zoom movement action to transition to another zoom magnification set effective on the basis of a second operation of instructing switching among the zoom magnifications set effective.

(14)

The imaging device according to the above (13), in which
the control unit causes a display unit to display a magnification operation element associated with each of the plurality of zoom magnifications set effective, and sets an operation of the magnification operation element as the second operation.

(15)

The imaging device according to the above (13) or (14), in which
the control unit causes a display unit to display a switching operation element configured to instruct the switching among the plurality of zoom magnifications set effective, and sets an operation of the switching operation element as the second operation.

(16)

The imaging device according to any one of the above (1) to (15), in which
the control unit performs control to cause a display unit to display, as touch-enabled icons, a setting icon indicating a setting state and capable of performing a setting change operation, and an operation icon configured to instruct the imaging device to operate.

(17)

The imaging device according to the above (16), in which
the control unit performs control
to cause the setting icon and the operation icon to appear while an icon-touch operation function is enabled, and
to cause the setting icon to appear and cause the operation icon to disappear while the touch operation function is disabled.

(18)

The imaging device according to the above (16) or (17), in which
the display unit is capable of changing an orientation relative to an imaging device main body, and
the control unit performs control to change display positions of the setting icon and the operation icon in a screen on the basis of an orientation state of the display unit.

(19)

The imaging device according to any one of the above (16) to (18), in which
the operation icon includes an icon acting as an operation element of the first operation or an icon acting as an operation element configured to call the icon acting as the operation element of the first operation.

(20)

A zoom control method applied to an imaging device including a storage unit configured to store zoom setting information that is set by an operation and includes at least one of a zoom time, a zoom speed, or a target zoom magnification, the zoom control method including
performing, on the basis of a first operation acting as a trigger for starting zoom variation that causes a zoom magnification to change to a wide-end side or a tele-end side, the zoom variation reflecting the zoom setting information.

### REFERENCE SIGNS LIST

1 Imaging device
12 Imaging element unit
15 Display unit
17 Operation unit
18 Camera control unit
19 Memory unit
30 Setting icon
40 Operation icon
42 Zoom entry button
46 Step zoom button
47 Auto zoom button
48 Zoom menu
61 W-side auto button
62 T-side auto button
63 Time-scheduled auto icon
64 Speed setting icon
65 W Button
66 T Button
67 Magnification button
100 Main body housing
101 Display panel
110C1 Custom button
110C2 Custom button
110Z Zoom lever

1. An imaging device comprising:
a storage unit configured to store zoom setting information that is set by an operation and includes at least one of a zoom time, a zoom speed, or a target zoom magnification; and
a control unit configured to perform, on a basis of a first operation acting as a trigger for starting zoom variation that causes a zoom magnification to change to a wide-end side or a tele-end side, the zoom variation reflecting the zoom setting information.

2. The imaging device according to claim 1, wherein
the zoom setting information includes the zoom time and the zoom speed,
the zoom time indicates a maximum duration during which the zoom variation is performed, and
the control unit performs control to start the zoom variation at the zoom speed on a basis of the first operation.

3. The imaging device according to claim 2, wherein
the control unit performs control to perform the zoom variation at the zoom speed within a range not exceeding the zoom time.

4. The imaging device according to claim 1, wherein
the zoom setting information includes the zoom time,
the zoom time indicates a duration during which the zoom variation is performed, and
the control unit obtains the zoom speed from a zoom variation distance and the zoom time and performs control to start the zoom variation at the zoom speed that has been obtained on a basis of the first operation.

5. The imaging device according to claim 4, wherein
the control unit obtains the zoom speed using a distance corresponding to a zoom magnification difference between a current zoom position to a zoom end as the zoom variation distance on a basis of the first operation.

6. The imaging device according to claim 1, wherein
the control unit performs control to cause a display unit to display an operation element configured to specify a wide side or a tele side and sets a wide-side operation or a tele-side operation via the operation element as the first operation.

7. The imaging device according to claim 1, further comprising
a hardware operation element that is operation-configurable, wherein
in a case where a wide-side auto zoom operation or a tele-side auto zoom operation is assigned to the hardware operation element, the control unit sets the hardware operation element as the first operation of specifying either the wide side or the tele side.

8. The imaging device according to claim 1, wherein,
in a case where the zoom variation based on the first operation is performed, the control unit performs control to perform a display indicating a planned angle of view at the end of the zoom variation.

9. The imaging device according to claim 1, wherein
the control unit
performs control to perform a display indicating a zoom variation status during a period where the zoom variation based on the first operation is in progress.

10. The imaging device according to claim 1, wherein
the control unit
performs to control to, during a period where the zoom variation based on the first operation is in progress, display indicating that the zoom variation is in progress.

11. The imaging device according to claim 1, wherein
the zoom setting information includes the zoom time, and
the control unit
performs display control of a time icon indicating the zoom time included in the zoom setting information, and
further performs processing of changing a setting of the zoom time on a basis of an operation of the time icon.

12. The imaging device according to claim 1, wherein
the zoom setting information includes the zoom time, and
in a case where the zoom variation based on the first operation is performed, the control unit performs control to perform a display indicating a planned angle of view at the end of the zoom variation, and
further performs control to change the display indicating the planned angle of view at the end of the zoom variation in response to processing of changing a setting of the zoom time.

13. The imaging device according to claim 1, wherein
the zoom setting information includes a setting indicating that a plurality of the zoom magnifications is set effective, and
the control unit performs control to perform a zoom movement action to transition to another zoom magnification set effective on a basis of a second operation of instructing switching among the zoom magnifications set effective.

14. The imaging device according to claim 13, wherein
the control unit causes a display unit to display a magnification operation element associated with each of the plurality of zoom magnifications set effective, and sets an operation of the magnification operation element as the second operation.

15. The imaging device according to claim 13, wherein
the control unit causes a display unit to display a switching operation element configured to instruct the switching among the plurality of zoom magnifications set effective, and sets an operation of the switching operation element as the second operation.

16. The imaging device according to claim 1, wherein
the control unit
performs control to cause a display unit to display, as touch-enabled icons, a setting icon indicating a setting state and capable of performing a setting change operation, and an operation icon configured to instruct the imaging device to operate.

17. The imaging device according to claim 16, wherein
the control unit performs control
to cause the setting icon and the operation icon to appear while an icon-touch operation function is enabled, and
to cause the setting icon to appear and cause the operation icon to disappear while the touch operation function is disabled.

18. The imaging device according to claim 16, wherein
the display unit is capable of changing an orientation relative to an imaging device main body, and
the control unit performs control to change display positions of the setting icon and the operation icon in a screen on a basis of an orientation state of the display unit.

19. The imaging device according to claim 16, wherein
the operation icon includes an icon acting as an operation element of the first operation or an icon acting as an operation element configured to call the icon acting as the operation element of the first operation.

20. A zoom control method applied to an imaging device including a storage unit configured to store zoom setting information that is set by an operation and includes at least one of a zoom time, a zoom speed, or a target zoom magnification, the zoom control method comprising
performing, on a basis of a first operation acting as a trigger for starting zoom variation that causes a zoom magnification to change to a wide-end side or a tele-end side, the zoom variation reflecting the zoom setting information.
